(19) United States
(12) Patent Application Publication
(10) Pub. No.: US 2021/0154065 A1
(43) Pub. Date: May 27, 2021

(54) ELEVATING WALKER CHAIR AND CONVERTIBLE SEAT

(71) Applicant: Exokinetics, Inc., West Chester, PA (US)

(72) Inventors: Garrett W. Brown, Philadelphia, PA (US); John Christopher Fawcett, Whitehead, Antrim (GB)

(73) Assignee: Exokinetics, Inc., West Chester, PA (US)

(21) Appl. No.: 16/965,061

(22) PCT Filed: Mar. 26, 2019
(86) PCT No.: PCT/US2019/024074

§ 371 Date: Jul. 27, 2020

Related U.S. Application Data
(63) Continuation-in-part of application No. 15/326,113, filed on Jan. 13, 2017, now Pat. No. 10,842,706.
(60) Provisional application No. 62/649,746, filed on Mar. 29, 2018.
(60) Provisional application No. 62/649,809, filed on Mar. 29, 2018.
(60) Provisional application No. 62/822,496, filed on Mar. 22, 2019.
(60) Provisional application No. 62/024,006, filed on Jul. 14, 2014.

(51) Int. Cl. A61G 5/14; A61H 3/04; A61G 5/10

(52) U.S. Cl. CPC A61G 5/14; A61H 3/04; A61G 5/125; A61G 5/1062; A61G 5/1059

(57) ABSTRACT

A convertible seat and an elevating walker chair having a convertible seat. The chair elevates by a parallelogram mechanism that can be functionally connected to a seat deployment mechanism to allow the seat to transform between a saddle and seat upon changes in saddle/seat elevation.

This application claims priority to U.S. provisional application No. 62/649,746, filed Mar. 29, 2018, entitled Elevating Walker Chair, Lifting Mechanism And Seat; U.S. provisional application No. 62/649,809, filed Mar. 29, 2018, entitled Lifting Chair; U.S. application Ser. No. 15/326,113, filed Jan. 13, 2017, entitled Elevating Walker Chair, which is national phase application of PCT/US2015/040036, filed Jul. 10, 2015, entitled Elevating Walker Chair, which claims priority to U.S. provisional application No. 62/024,006, filed Jul. 19, 2014, entitled Elevating Walker Chair, all of which are hereby incorporated by reference.

### BACKGROUND

Conventional devices to assist individuals having mobility difficulties fall into two broad categories—walkers and wheelchairs—plus several intermediate combinations that may additionally help occupants rise up and ambulate.

Conventional walker devices add support and stability but involve the user's hands and arms to an extent that precludes carrying or manipulating anything while moving. Four-wheeled walkers may also include seats, but they cannot be employed unless the user stops and turns around.

Walkers are slow and isolating, and inherently dangerous when set aside in order sit down.

Most non-powered and powered wheelchair users remain interminably seated, at the expense of muscular, circulatory, and cardiac well-being.

‘Elevating’ wheelchairs employ large motors to raise strapped-in occupants to a standing position and some can power them from place to place while upright, but without reinforcing ambulatory abilities or requiring any muscular contribution

Another intermediary category of assistive devices includes ‘stand-up’ walkers, which partly lift occupants up and down and encourage them to walk.

Unfortunately, existing stand-up walkers inhibit user interactions with the world—either by having large structures ahead and rear entry, or with clumsily uncomfortable folding seats, procedures and restraints. And the users must still lift a significant percentage of body weight with legs and arms in order to rise from a seated to a standing position.

What is missing is a means for individuals with ambulatory limitations to sit and stand at will, to walk with a natural gait, and to safely and easily interact with their environment—to cook, clean, do the wash, get dressed and transport themselves—all at the altitude desired, and with at least a small component of their own energy and former athleticism.

### SUMMARY

Disclosed is an elevating walker chair, which may be beneficial for people with limited mobility resulting from compromised musculature, coordination or balance, or for able bodied individuals that must perform tasks for which assistance is desired. The disclosed elevating walker chair provides a novel hybrid of riding and walking that may encourage ones normal gait yet will typically prevent falling. An illustrative embodiment allows a user to stroll, stride and coast, and relatively easily sit down and rise up—all in a functionally equipoised and weightless, or near weightless, condition—without having to exit the device, and with hands free as needed for other purposes.

Disclosed embodiments include a seat deployment mechanism and a lifting mechanism, which may be functionally connected to the seat deployment mechanism. The seat deployment mechanism transforms a convertible seat between seat and saddle configurations. The lifting mechanism raises and lowers the elevating walker chair. When functionally connected, the lifting mechanism causes the seat deployment mechanism to be transformed between seat and saddle according to the height to which the elevating walker chair is raised or lowered.

### DESCRIPTION OF THE DRAWINGS

All figures and descriptions are directed to illustrative embodiments. Equivalents of specific configurations of the elevating walker chair and its component parts and mechanisms are intended to be included in the disclosure. The following figures depict illustrative embodiments:

FIG. 1 depicts a full isometric view of an elevating walker chair.

FIGS. 2A-B depict side elevations of the chair of FIG. 1 showing a saddle/seat unfolded to form a chair in the lowered position, and with wings folded to form a saddle in the raised position.

FIGS. 3A-B depict isometric views of a lifting chassis including parallelogram struts, and a transparent rendering of a resilient lifting cassette.

FIGS. 4A-B depict side elevations of two alternate positions of a cassette axle, generally associated with differences in payload lifting performance.

FIGS. 5A-B depict side elevations of various selected mounting angles for lifting an extension frame to yield potentially identical lifting performance if lifting-frame angle to cassette centerline angle is consistent.

FIGS. 6A-C depict deployment positions for left/right armrest assemblies that lock and unlock the seat height and rear wheels, as the user transitions from seat mode, upward to saddle mode and ambulation.

FIGS. 7A-D depict progressive engagement by a user with the actuating armrest control functions, as he boards and effects a downward transition to seated height.

FIG. 8 depicts armrests employed to stabilize and partly support an ambulating user, riding on folding saddle/seat and displaying a posture for walking, striding and/or coasting.

FIGS. 9A-C illustrate an arm/hand actuating armrest assembly with a top cover plate and associated armrest positions yielded by excursions of fore/aft uneven-parallelogram struts.

FIG. 10 depicts a folding seat/saddle assembly with a wing and seat mounting block, showing how a seat mounting post facilitates limited dynamic side-to-side swiveling of the seat/saddle in order to provide a path for rearwardly striding legs.

FIGS. 11A-B depict a saddle/seat and show how a seat wing is swung upward by a wing deployment strut into seat mode as the saddle descends.

FIGS. 12A-B depicts an elevating lifting chair that lifts and lowers a seat carriage assembly between walking and seat heights by means of a left/right resilient member and linear bearing assemblies.

FIGS. 13A-B depict rear isometric views of a low seat and elevated saddle deployment of an elevating walker chair suitable for industrial use that provides support for the combined weight of a workman or other user, a resiliently powered payload support arm and a gimbaled industrial tool payload.

FIG. 14 depicts a maximum height adjusting screw and striker plate assembly to set maximum saddle height as appropriate for a user's inseam measurement.

FIGS. 15A-C depict a seat for an elevating lifting chair than transforms between a saddle shape and a more flattened seat shape.

FIG. 16 depicts an articulated arm attached to a gimballed tool holder.

FIGS. 17A-D depict an illustrative armrest with cam or crankshaft axles that actuate braking and lift-locking functions through sequential deployment positions.

FIGS. 18A-B depict the underside of a seat in saddle mode for an elevating walker chair and illustrate a seat swivel function.

FIGS. 19A-B depict a further illustrative embodiment of a seat that transforms from a seat configuration to a saddle structure that can be integrated with any of the disclosed frames and lifting mechanisms.

FIGS. 20A-B depict the underside of the seat of FIGS. 19A-B in a seat configuration and saddle configuration, respectively.

FIG. 21A is a cross-sectional view taken through A-A of FIG. 21B.

FIG. 21B depicts the underside of the seat depicted in FIG. 19A.

FIG. 22A is a cross-sectional view taken through B-B of FIG. 22B.

FIG. 22B depicts the underside of the seat depicted in FIG. 19B.

FIG. 23A is a cross-sectional side view of an elevating walker chair taken through C-C of FIG. 23B.

FIG. 24 is an enlargement of the extension frame of a lifting mechanism.

FIG. 25 depicts a car of a lifting mechanism.

FIG. 26A is a cross-sectional side view taken through D-D of FIG. 26B.

FIG. 26C depicts an elevating walker chair showing a parallelogram of the lifting mechanism in broken lines.

FIGS. 27A-B depict a seat with a seat deployment mechanism connected to a lifting mechanism, in lowered and elevated positions.

FIGS. 28A-B depict illustrative specifications that affect forces and performance of an elevating walker chair.

FIGS. 29A-B depict illustrative specifications that affect forces and performance of an elevating walker chair according to a further arrangement.

FIG. 30 depicts an elevating walker chair at a higher level of excursion than is shown in FIGS. 28A, 29A.

FIG. 31 depicts an elevating walker chair at a higher level of excursion than is shown in FIGS. 28A, 29A according to a further configuration.

FIG. 32 is an isometric view of a linear bearing assembly running between a linear bearing track pair.

### DETAILED DESCRIPTION

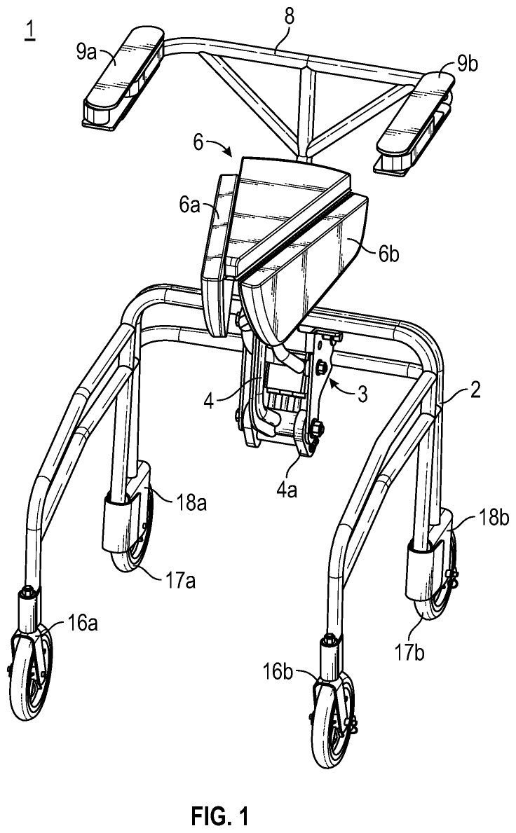

FIG. 1 depicts an isometric view of an elevating walker chair 1 according to an illustrative embodiment , seen in its elevated ‘walking’ position, including wheeled frame 2 attached to lifting chassis 3, components of which resiliently pivot lifting extension frame 4a downward and attached lifting strut 4 upward, with a force calibrated to permit folding saddle/seat 6 to equipoise its occupant by counterbalancing the occupant's weight to provide an essentially “weightless” condition, as the frame rises toward the upward limit of its parallelogram-supported excursion.

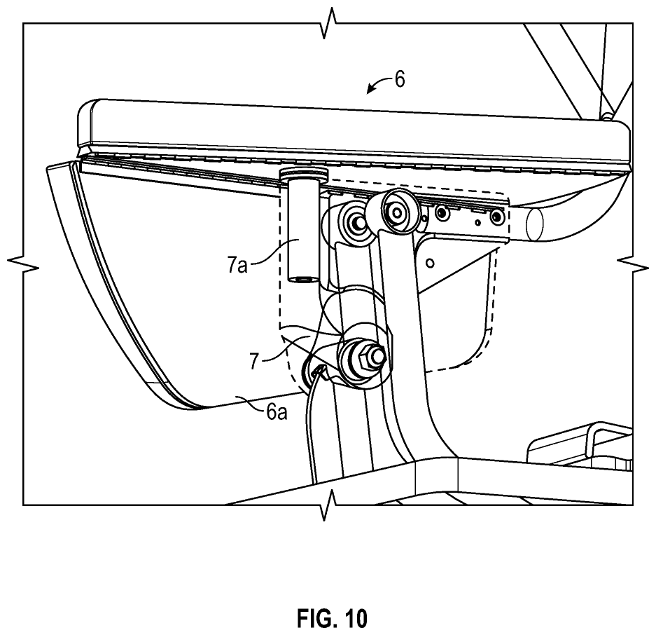

Armrest/seat back frame 8 is attached to seat mounting block 7 (shown in FIG. 10), and supports armrest assemblies 9a, 9b. Left and right folding seat wings 6a, 6b are shown folded downward in the ‘saddle’ position, which is suitable for elevated seating. Armrests 6a,b are shown in a retracted position, but can be optionally forward deployed, which can aid in supporting the torso in a position for walking. Sufficient clearance of the seat with respect to the ground frame 2, including to the sides of the seat and below is provided to permit a walker's legs and feet to stride to the rear or to engage the ground sideways if desired.

Because embodiments of the elevating walker chair permit ambulation without frontal obstructions as found in traditional walkers, a user will retain forward access at various heights, including a standing height, to sinks, stoves, closets, etc. and will be able to maneuver in between.

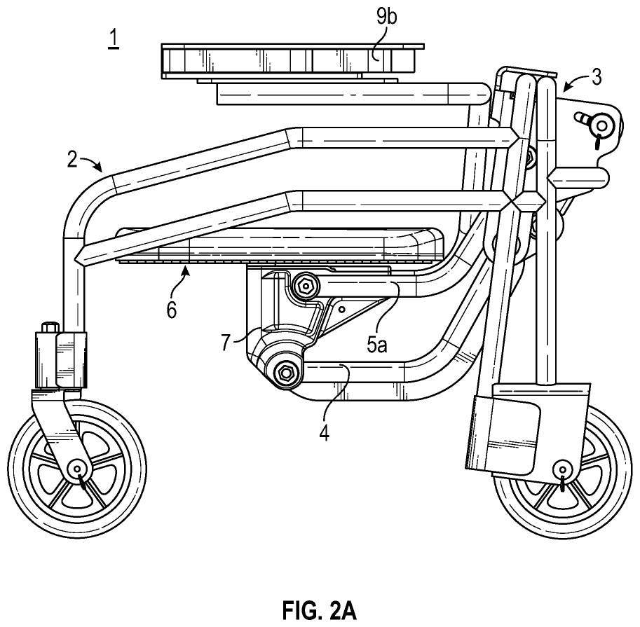

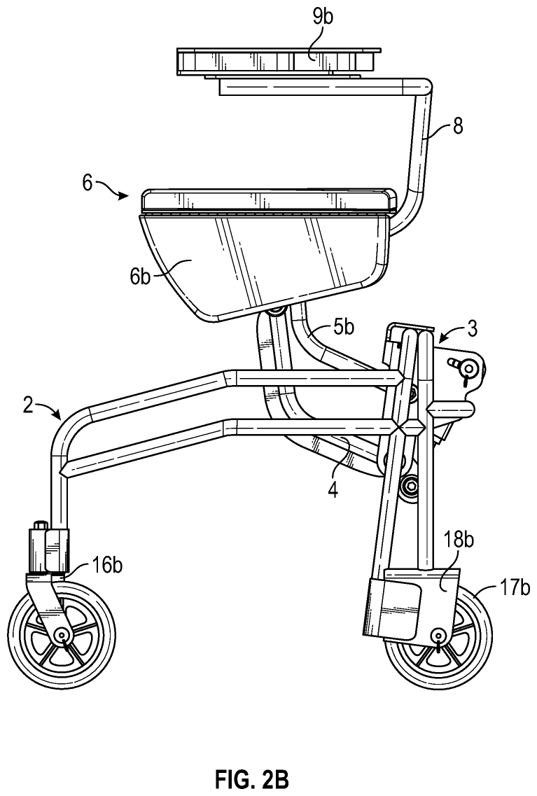

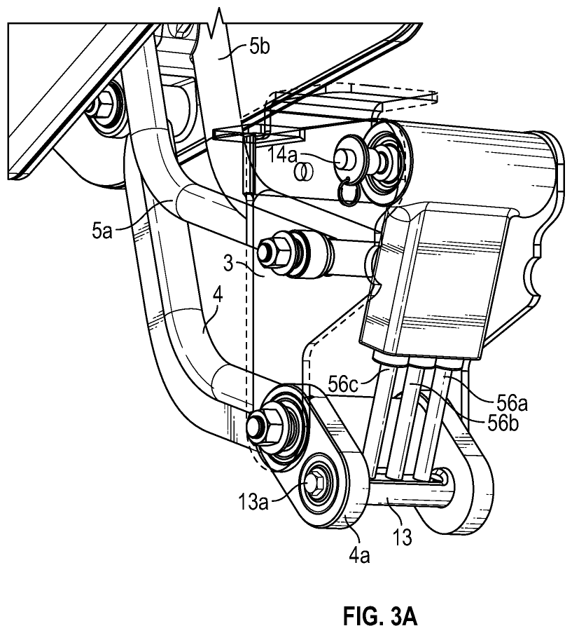

FIGS. 2A-B depict side elevations of elevating walker chair 1. FIG. 2A shows saddle/seat 6 unfolded to form a chair when elevating walker chair 1 is in its lowest, chair-height position (“sitting mode”). The chair height is modified by a parallelogram apparatus formed by seat mounting block 7, lower parallelogram lifting strut 4, upper parallelogram struts 5a,b and lifting chassis 3. In the sitting mode position, elevating walker chair 1 functions as a conventional chair, which can optionally include an upholstered seat back and padding for armrests 9a,b. Seat frame 2 can be formed of any appropriately strong material including carbon fiber, curved aluminum box beam, etc. Note that lifting strut 4 and parallelogram struts 5a,b are bent in the illustrative embodiments depicted in the drawings. The bends allow the seat to occupy space that would not otherwise be available, thereby increasing the excursion distance of seat 6 as compared to an embodiment wherein the struts are straight.

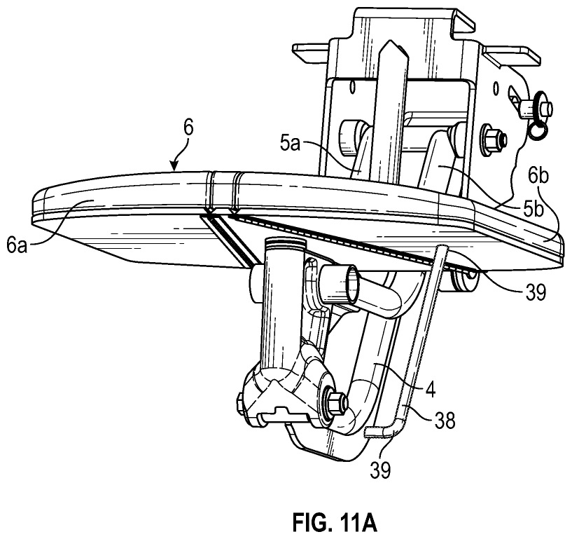

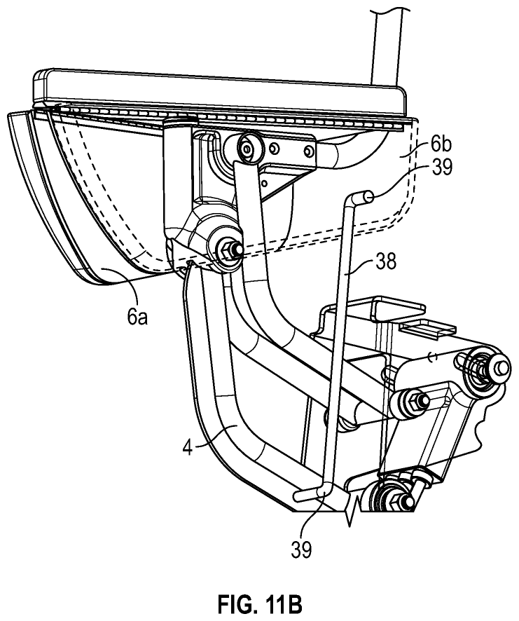

FIG. 11A illustrates the position of seat 6 within curved parallelogram struts 5a,b. The bends allow the back edge of seat 6 to clear the struts when the seat is lowered. Curved lifting strut 4 can also enlarge the available space for seat 6. Although lifting strut 4 and parallelogram struts 5a,b are curved, they are configured to perform in a manner analogous to configurations with straight parallelogram sides.

FIG. 2B shows seat 6 elevated to a selected position pursuant to which a user may ambulate with the use the user's legs. Seat wings 6a,b are folded down to form a tapered saddle configuration of seat 6. Seat frame 8, which is attached to a seat mounting block and supports armrest assemblies 9a,b. Rear wheels 17a,b are preferably of fixed orientation, i.e. non-swivelable, and may be attached to motor mounting plates 18a,b, which can be adapted to receive conventional small, self-contained motor and battery sets (not shown), to optionally supplement foot and leg power as needed, and assist steering maneuvers by applying forward and reverse torques to rear wheels 17a, 17b. A preferably wireless joystick (not shown) can be attached to the top surface of armrest 9a or 9b, to add slight forward, rearward or turning motive power as needed, to just the degree required to supplement an individual's abilities.

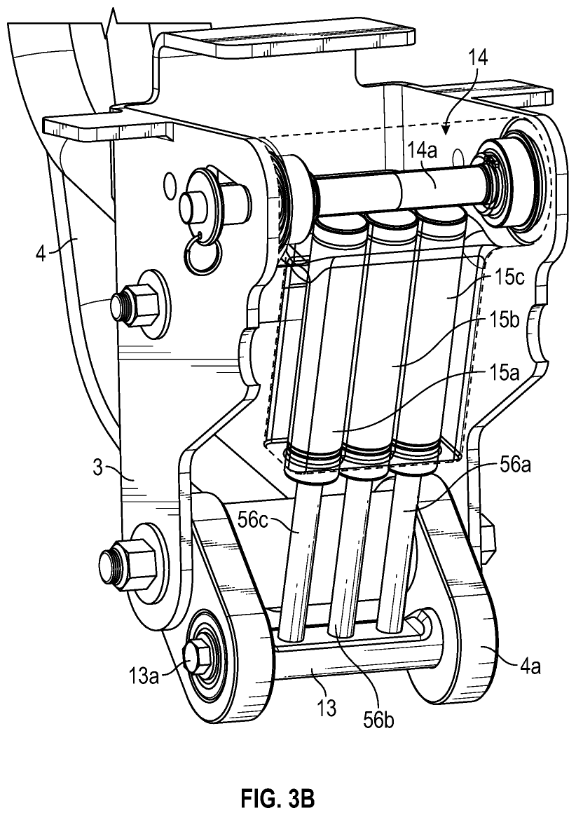

FIG. 3A depicts an isometric view of lifting chassis 3 that includes a lifting cassette 14 that houses resilient power units 15a,b,c (shown in FIG. 3B). Extendable shafts 56a,b,c of resilient power units 15a,b,c are shown engaging receiver bar 13. Receiver bar 13 pivots on axle 13a within the end of lifting extension frame 4a, which is connected to and pivots lower parallelogram lifting strut 4 upward to elevate saddle/seat 6 and its human payload.

FIG. 3B includes a rendering of resilient lifting cassette 14, showing its internally-mounted resilient power units 15a,b,c—such as small, powerful gas springs, for example. Resilient power units 15a,b,c can be selected in a combination that will equipoise or counterbalance, fully or closely, the weight of the seat occupant. Cassette 14 pivots within chassis 3 around axle 14a so that resilient power units 15a,b,c (such as gas springs) can remain extended to receiver bar 13. Since the resilient power units 15a,b,c can provide a powerful compression force, they bias lifting extension frame 4a strongly downward, in the manner of the heavier occupant on the short end of a seesaw, who can counterbalance the lighter occupant on a much longer end. In fact, since the effective pivot-to-pivot length of lifting strut 4 in this embodiment is about 6.9 times the pivot length of lifting extension frame 4a, for example, then the sum of the forces exerted by a given set of resilient power units 15a,b,c can be divided by that ratio to indicate the approximate weight of a person they would support. For a closer approximation, the weight of seat 6 must be included, minus approximately half the separate weight of the persons legs—but in practice it is found that a person's weight plus about 10 lbs. provides a good indication of the net resilient unit(s) lifting power that will successfully ‘float’ the person in an equipoised condition that lets them rise up and sit down as if in an approximation to “zero gravity.”

The chart below illustrates the net lifting value of some available gas spring type resilient power units, as may be illustratively employed in embodiments of the lifting mechanism. It can be seen that the most powerful gas spring in this list will actually lift a net payload of nearly 100 lbs. (at the forward payload end of the lifting parallelogram) as each cassette is pressured to provide up to 691 lbs. of extending force.

Even though outer gas springs (15a and 15c) should be selected to be identical (to avoid drastically off-center loads on receiver bar 13 and extension frame 4a), it is clear that combinations of available net lifting values can easily be specified to approximately ‘float’ nearly anyone weighing from 80 lbs. to 300 lbs.

Combinations of resilient power units 15a,b,c can include for example, a single central spring, two identical outer springs, or a combination of one inner and two identical outer springs. Other numbers of individual resilient power units can be used; however, it is preferable to avoid off-centered forces. In an illustrative embodiment of the lifting mechanism, combinations are selected to equal the rider's weight plus about 10 lbs.

The chart below shows parameters of illustrative gas springs. The gross lift is that which the spring inherently possesses. The net lift is the gross lift divided by 6.9, which is an illustrative ratio between the length of lifting strut 4 and extension frame 4a. In this illustration, all springs have a shaft excursion of 3.15 inches.

| Net Lift (lbs.) | Gross Lift (lbs.) |
|---|---|
| 6 | 40 |
| 12 | 81 |
| 16 | 94 |
| 18 | 121 |
| 23 | 157 |
| 25 | 173 |
| 32 | 220 |
| 42 | 292 |
| 50 | 346 |
| 75 | 519 |
| 100 | 690 |

Springs or other resilient power units of different powers typically have different outer diameters or other dimensions. To easily switch resilient power units, a standard connection or other accommodation may be present in the lifting cassette, and an adaptor, such as a standard diameter sleeve may be provided to render all resilient power units of a form compatible with resilient lifting cassette 14.

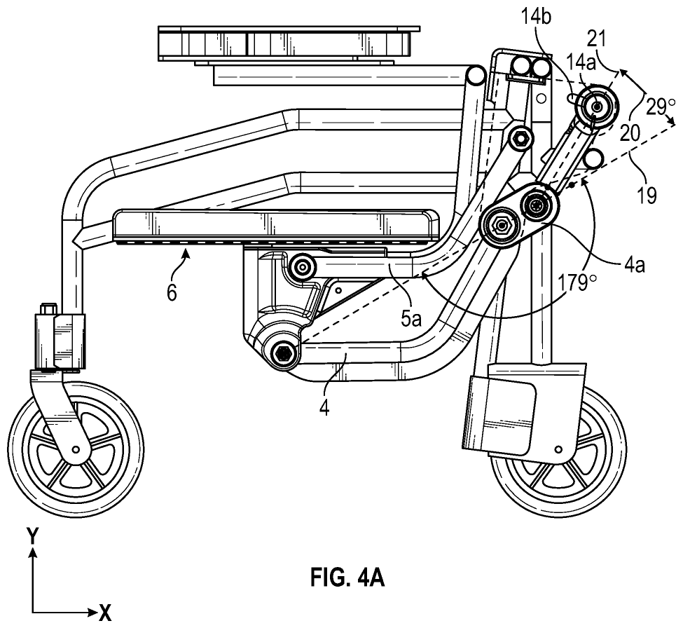

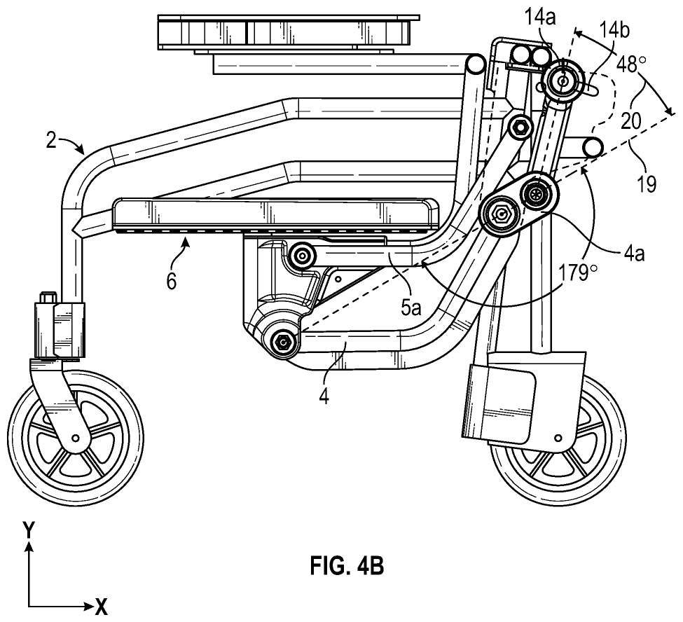

FIGS. 4A-B depict side elevations of elevating lifting chair 1 illustrating two alternate positions of cassette axle 14a along slot 14b that yield differences in payload lifting performance The term “iso-elasticity” refers to an exemplary lifting force profile, from lowest to highest excursion, obtained by parallelogram arms designed to float, analogous to the counterbalance force profile of a Steadicam®' camera stabilizer. Iso-elasticity may be desirable for lifting human beings so they do not need muscle power to rise from a seated to a standing position, but unlike camera payloads, sitting humans, rising to become saddle-borne humans, weigh varying amounts throughout this transition. In practice, though most of a person's weight bears initially on the seat, the remainder (approximately half the weight of legs and feet) actually bears on the floor—and this proportion varies as someone prepares to stand up. As he or she leans forward to rise, significantly more leg weight is transferred from seat to floor. The result is that to actually ‘equipoise’ or effectively ‘zero-g’ a person throughout this transition, the amount of lift provided must likewise vary, and it is found that a consistent, ‘iso-elastic’ lift may rise too rapidly at first and then too slowly as the saddle-born occupant nears a standing posture. Accordingly, the lifting force profile may be varied to provide greater lifting force over an initial portion of the excursion from sitting mode to standing mode, compared to the lifting force exerted by the lifting mechanism as the occupant nears standing. The varied lifting force may gradually increase from the sitting mode to the standing mode of an elevating lifting chair, rather than change in discreet increments.

FIG. 4A illustrates an angle between lifting extension centerline 19 and the force applied along cassette centerline 21, that may be optimal. The angle is achieved in this illustrative embodiment when cassette axle 14a is slid to the “rear” of adjustable cassette positioning slot 14b. The resultant 29° lifting angle, in this embodiment yields a ‘super-iso-elastic’ lifting force curve that would cause an inert payload to drop excessively at the bottom of travel and rise too energetically at maximum height, but that is preferable for lifting up humans whose legs remain in contact with the floor. An illustrative angle range is from about 27° to about 31°. The resulting ‘super-iso-elasticity’ may yield appropriate lifting force for two reasons: First, it is powering a limited excursion at a high ‘see-saw’ ratio of force to payload weight. And second, the momentary extending force of the selected gas springs along cassette centerline 21 is applied in a direction optimally to lifting extension centerline angle 19 throughout its travel. The initial 29° force angle is inefficient for lifting and lets the occupant remain seated until he or she leans forward, thus transferring sufficient leg/foot weight to the ground to launch the parallelogram upward. The angle of the force applied to the short lever arm, designated as lifting extension frame 4a, reaches 119° just as seat 6 reaches its maximum upward position (and attains a saddle configuration). At this extension, gas springs 15a,b,c exert only about 0.6 of their original force, but at a relatively efficient angle to extension centerline 19, which would cause an inert payload to bump hard against the upper stops. However once the occupant's legs approach vertical and a larger percentage of his or her weight rests on the saddle, the lifting performance can more effectively equipoise the human payload.

FIG. 4B, by contrast, illustrates the optimal ‘iso-elastic’ lifting angle of 48° which, in this illustrative embodiment, would evenly lift an inert non-human payload. However, the dynamically varying human payload, as described above, would find difficulty getting himself or herself down to seat height. Particularly since a portion of descending inertia is in practice diverted to activate seat deployment (as shown in FIGS. 11A-B). And the occupant would also have difficulty reaching maximum height, since the diminishing proportion of leg weight reaching the ground would effectively make him or her heavier. Non-obviously therefore, though iso-elastic lift is achievable, it may not be optimal for the very particular requirements of human equipoising with regard to n elevating lifting chair.

An illustrative lifting angle range for a more beneficial varies iso-elastic excursion is about 46° to about 50°. Generally, as lifting angles increase above 48°, the payload will require externally added upward or downward force to reach respectively, the top or the bottom of travel, whereas a lifting angle less than 48° may cause the payload to require added upward force to rise from the lowest position, and downward force to descend from maximum height.

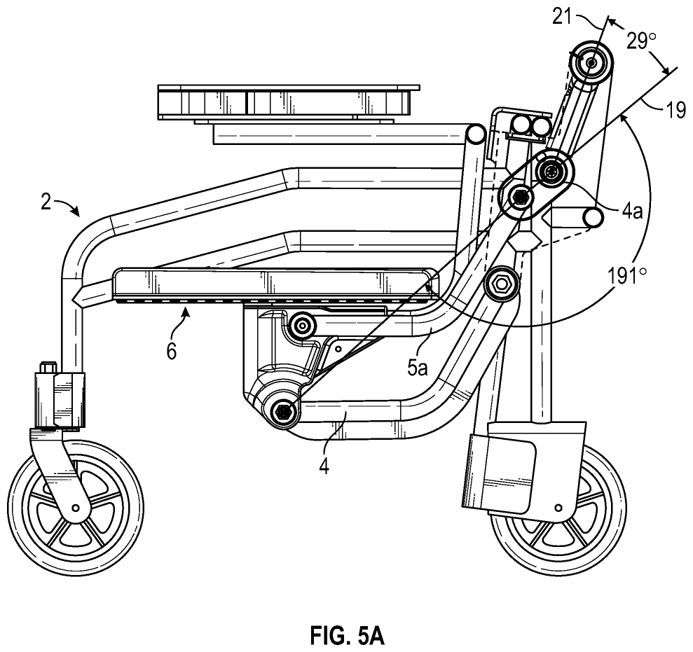

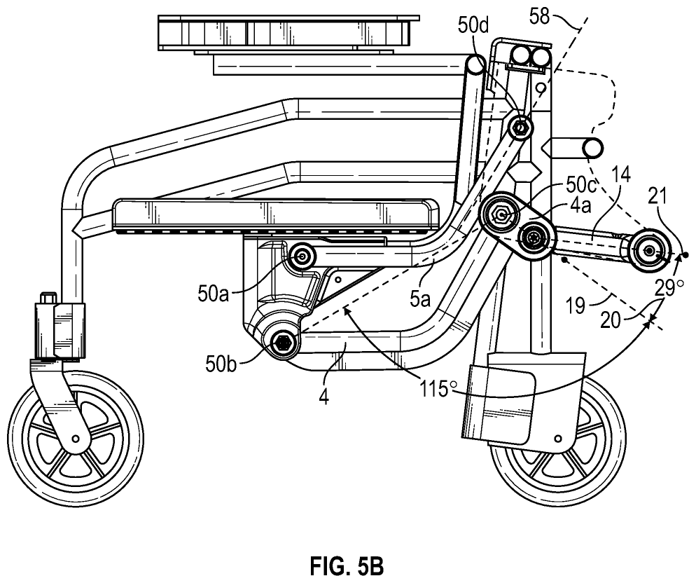

FIGS. 5A-B depict side elevations illustrating that various other selected mounting angles for lifting extension frame 4a can yield similar or identical lifting performance if the angle between resilient cassette centerline 21 and lifting-frame centerline 19 is, in each case, arranged to be 29° when seat 6 is at its lowest excursion. FIG. 5A illustrates a structural variation according to an illustrative embodiment of an elevating walker chair, in which lifting extension frame 4a is attached to upper parallelogram struts 5a,b instead of to lower parallelogram lifting strut 4 as in previous figures. Note that lifting performance can be similar or identical, and thus similarly suitable for human occupants, because the angle between lifting frame centerline 19 and cassette centerline 21 has been constructed to again be 29° or there about. This arrangement can be advantageous for several reasons, including that it keeps the lifting components higher up behind the backrest, and thus, more out of the way of rearward foot and leg excursions when striding and coasting.

FIG. 5B depicts another illustrative variation in the angular location of the lifting apparatus. In this view, the lifting extension centerline 19 is at nearly right angles to the longitudinal centerline 58 of the portion of lifting strut 4 to which lifting strut 4 attaches, and resilient lifting cassette 14 is sticking straight out to the rear. Note, however, that cassette centerline angle 21 is again at a 29° angle to lifting frame centerline 19, and so this version, though merely illustrative and not particularly functional, would deliver similarly or identically appropriate lifting performance for its human payload.

As shown in FIGS. 5A-B, extension frame 4a can be rotated to any desirable angle about the pivot center at its attachment to lifting strut 4, which is illustrated at an angle of 191 degrees in the FIG. 5A configuration, and 115 degrees for the FIG. 5B configuration. Rotation of extension frame 4a can position lifting cassette 14 as desired either inside or outside of the parallelogram defined by pivots 50a,b,c,d.

The lifting mechanism that includes lifting cassette 14, extension frame 4a and the associated parallelogram structure, can be used in other applications in which parallelogram lifting structures can be employed, i.e. not merely in the elevating lifting chair described herein. In other words, the lifting mechanisms described herein are in essence stand-alone mechanisms that can be incorporated into other devices that require the lifting function the apparatus provides. The sides of the parallelograms of these lifting mechanisms can be bent, such as lifting strut 4 and parallelogram struts 11a,b, or may be straight as in traditional parallelogram links. Bends in the parallelogram sides can be designed to allow the optimal excursion necessary for a particular application. The lifting mechanisms may be mounted on a stand, a fixed or moveable structure or even to a vest that a user would wear.

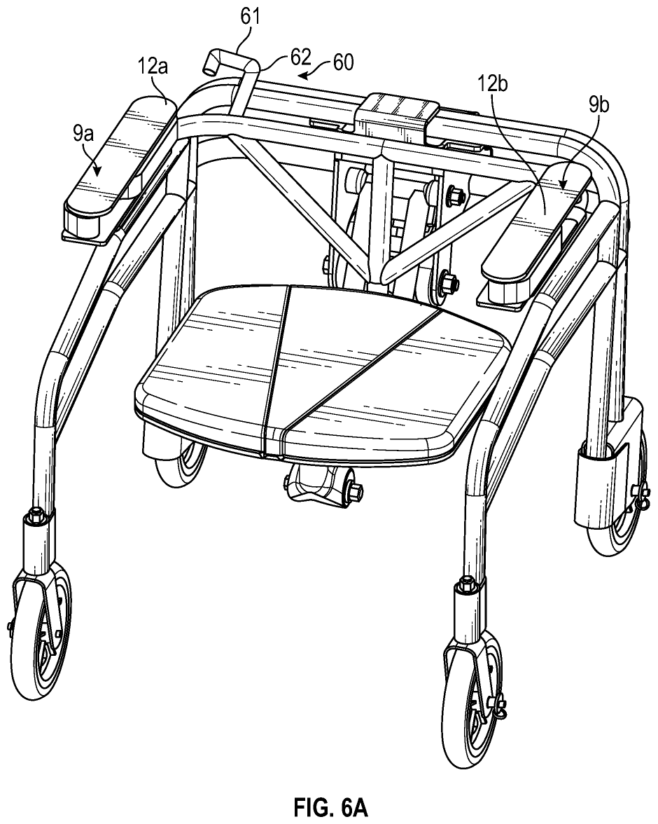

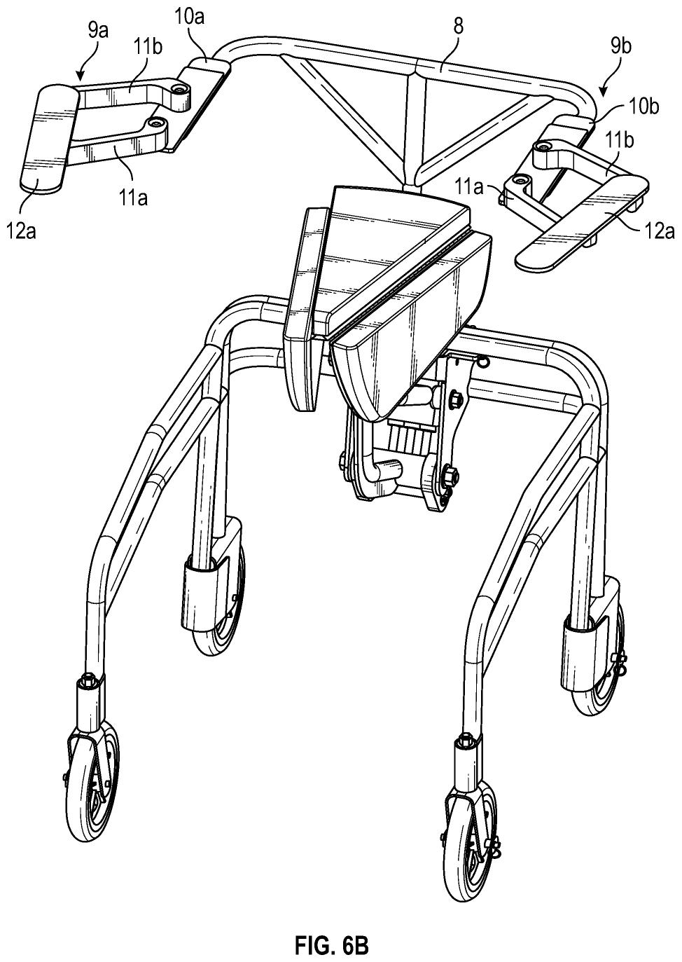

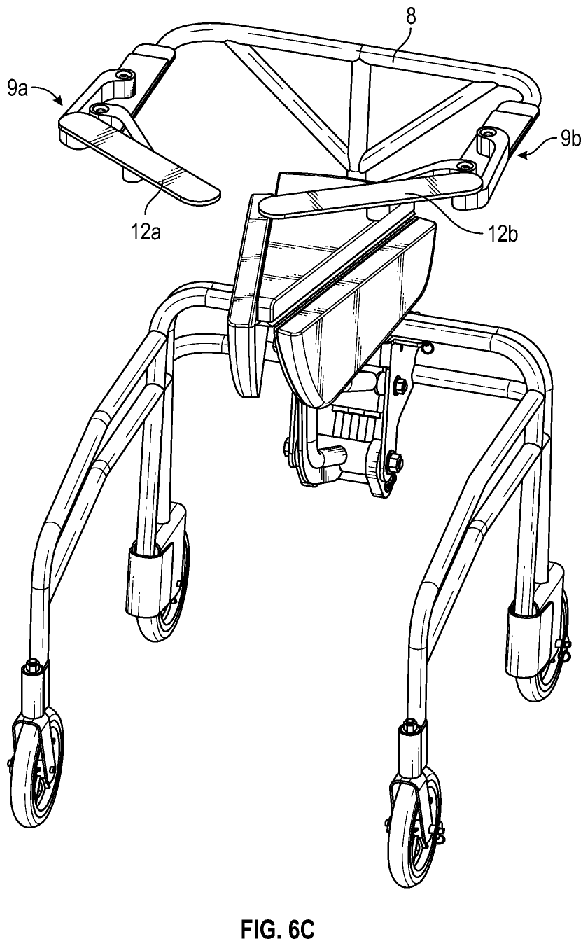

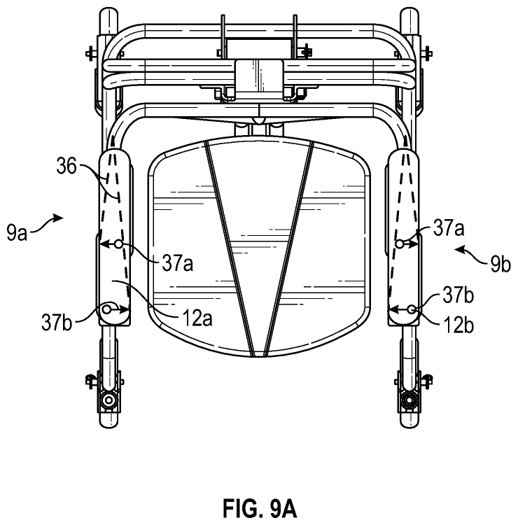

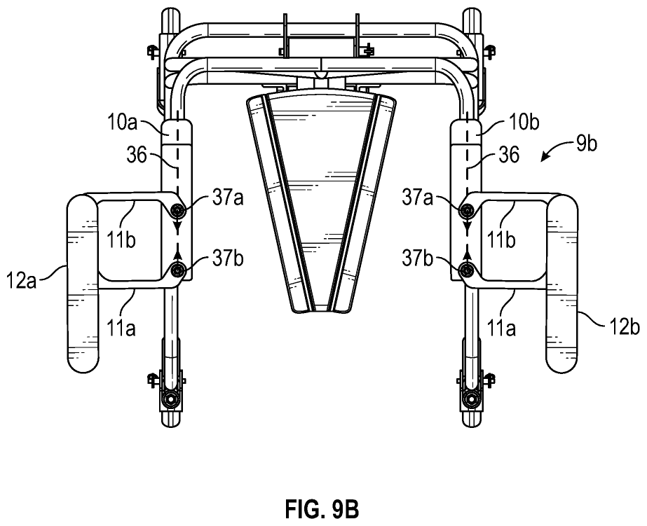

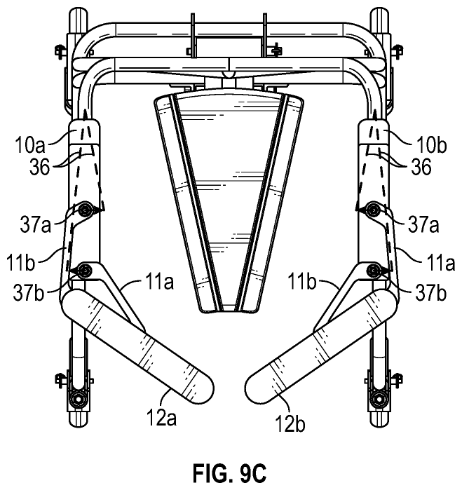

FIGS. 6A-C depict deployment positions for left/right armrest assemblies 9a,b that can be adapted to appropriately control the locking and unlocking of the seat height and rear wheels 17ab, as the user transitions from seat mode, upward to saddle mode and ambulation. FIG. 6A depicts the chair mode with armrests 9a,b fully retracted to serve as conventional armrests. FIG. 6B shows armrests 9a,b partially deployed. Fore/aft parallelogram deployment struts 11a,b are of uneven length and thus will begin to alter the angle of cover plates 12a,b with respect to armrest support plates 18a,b as they are swung out to the side. This armrest position is appropriate for ‘boarding’ the elevating walker chair. FIG. 6C illustrates the ultimate forward deployment of armrests 9a,b, in which the uneven parallelogram linkages swing cover plates 12ab back inward to form appropriate restraining and armrest surfaces appropriate for ambulation. As can be seen in FIGS. 9A-C, these three armrest positions will be employed to actuate the separate locking/unlocking of seat height and the rear wheel brakes in an illustrative embodiment of and elevating walker chair.

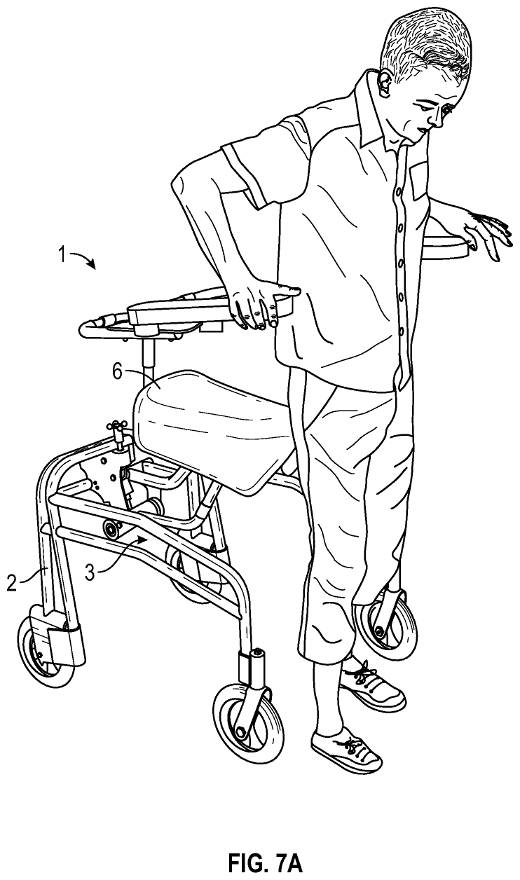

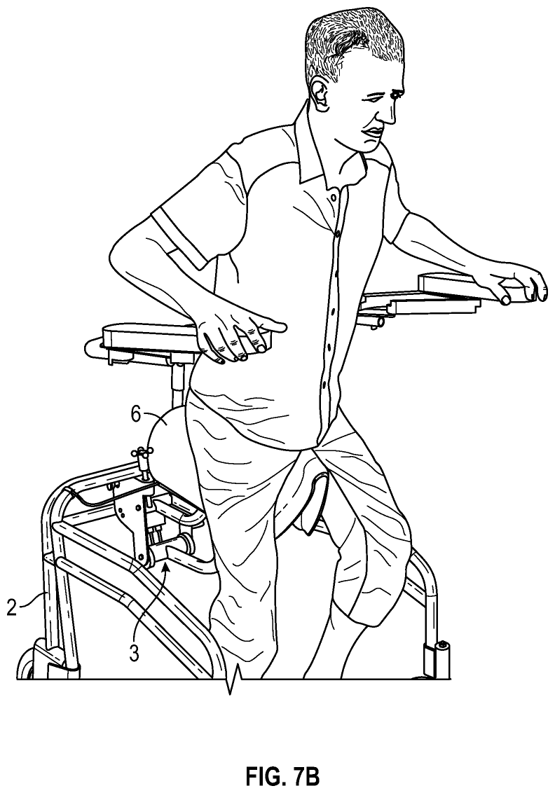

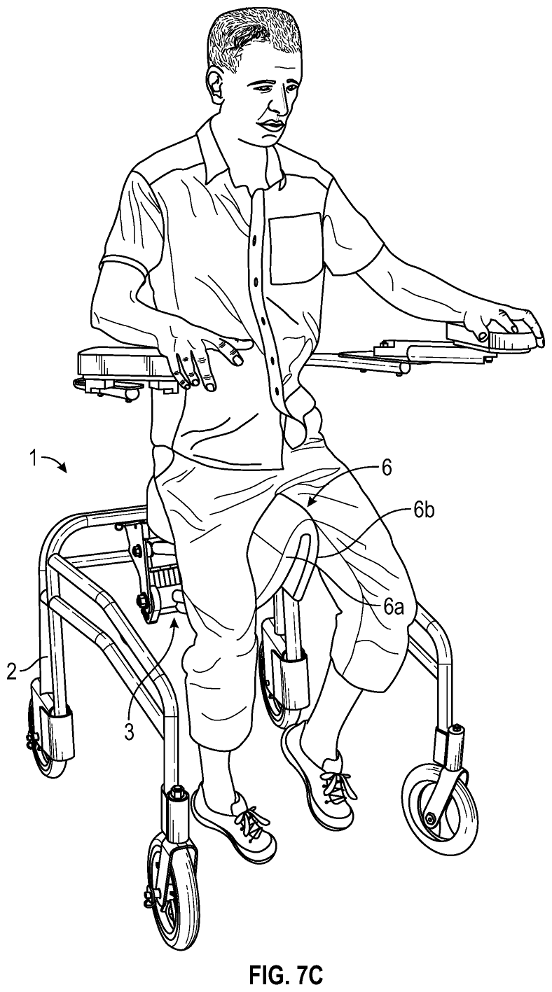

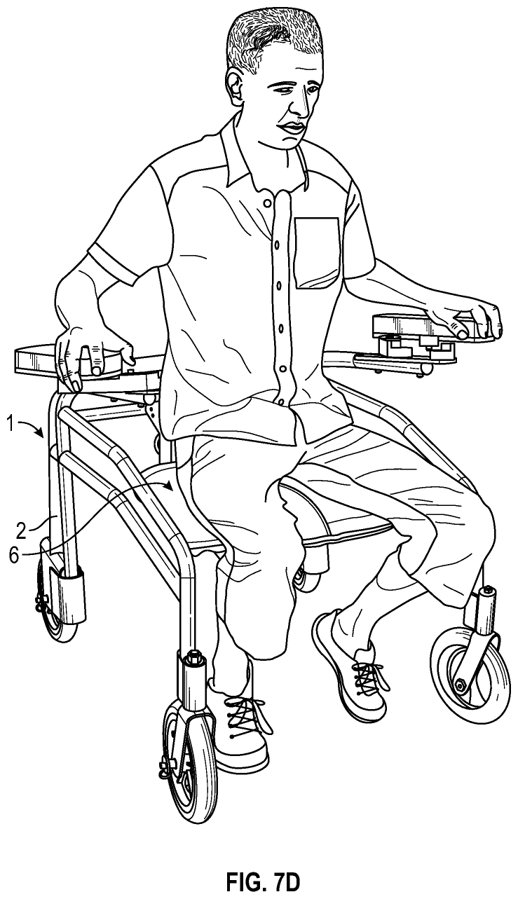

FIGS. 7AD depicts progressive engagement by a user with the novel actuating armrest control functions of an elevating walker chair, as he boards and effects a downward transition to seated height. In FIG. 7A, the user grasps the armrests in extended position (which preferably has locked the rear wheel brakes) and approaches the saddle. In FIG. 7B he transfers his weight to the saddle and preferably fastens his seatbelt (not shown). The extended armrest position also preferably unlocks seat height. In FIG. 7C the user can be seen leaning slightly back to cause the seat to descend, while supporting all but a few pounds of his weight. In FIG. 7D the user has descended to chair height, the seat wings have automatically deployed outward and the user pulls the armrests back toward their conventional sitting position, preferably actuating the seat height lock and freeing the brakes, (by means illustrated in FIGS. 9A-C).

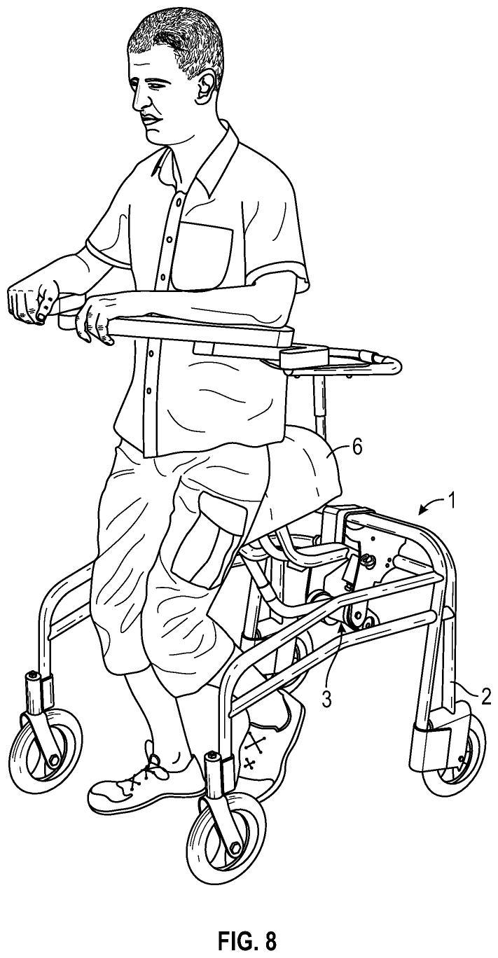

FIG. 8 depicts armrests 9a,b swung forward to a position appropriate for forward ambulation, enclosing the user, providing armrest surfaces that will facilitate ambulation, and if available in the embodiment, actuating the seat height lock, releasing the rear brakes. The user is shown in an appropriate posture for conventional walking. According to the user's level of fitness and ability, he or she may elect to lean further forward, transfer a bit more body weight to the armrests and stride with somewhat larger steps, coasting in between, and with feet and legs extending ground contact further to the rear.

An illustrative range of height variations, for example between the seated position of FIG. 7D and the striding position of FIG. 8, is about 18 inches to about 34 inches.

FIGS. 9A-C show right-hand actuating armrest assembly 9a depicted in perspective with transparent top cover plate 12a, to illustrate armrest positions yielded by excursions of fore/aft parallelogram struts 11a,b, which are uneven in length, and their respective actuating functions. The upper left image shows the position of the afore-mentioned components when the arm assembly is in its retracted position. The upper right image shows armrest assembly 9a easing sideways (preferably beginning to actuate right-rear wheel brake). The lower left drawing shows armrest 9a fully extended sideways (preferably unlocking the lifting function and implementing full braking). The lower right image shows armrest 9a in its forward-most position so top cover plate extends at least partially in front of a user, thereby enclosing, stabilizing and supporting ambulating activity, and preferably locking lift and actuating the release of the right-hand wheel brake. These functions will be further illustrated in FIGS. 9A-C.

FIGS. 9A-C depict armrest 9a showing an illustrative mechanism for actuating braking and lift-locking functions throughout sequential armrest deployment positions shown. Crankshaft axles 37a,b are fixed to fore/aft armrest deployment struts 11a,b so they rotate in unison. The arrows shown extending from crankshaft axles 37a,b in FIGS. 9A-C indicate the direction of attached arms associated with the crankshaft axles. The crankshaft arms are adapted to pull actuating wires 36, indicated by dotted lines on both armrests. The dotted lines show the path of the central wire-ends, which can be for example, from four conventionally-terminated bicycle-type brake cables (not shown). Actuated by crankshaft axle 37a, one end of wires 36 on each armrest are preferably adapted to conventionally actuate and release its respective-side rear wheel brake. The other end of wires 36 on each side, are driven by 180 degree crankshaft axles 37b in opposing directions, which can also be employed via bike cables (not shown), to activate one of two redundant seat-height locks (not shown). The seat height locks may comprise conventional disc brakes or hydraulic locking cylinder assemblies, among other conventional braking and restraining options, preferably acting to restrain both upward and downward excursions of the lifting parallelogram of the elevating walker chair.

FIG. 9A shows armrest assemblies 9a,b in their rearward seated position. Crankshaft arms associated with crankshaft axles 37a on both armrests are directed outward (indicated by arrows), with their dotted line brake-cables 36 adjusted to cause respective left/right wheel brakes to be released. Forward crankshafts arms associated with crankshaft axles 37b on each side are inwardly directed, and their brake-type cables adjusted to cause the seat height to be locked. FIG. 9B shows armrest cover plates 12a,b swung outward and crankshaft arms (represented by arrows) fixedly associated with crankshaft axles 37a,b on both armrests respectively rotated 90° as shown. Both left and right crankshaft arms have swung forward and therefore caused ends of brake wires 36 to be extended and respective left/right wheel brakes firmly engaged. Note also that respective left/right wheel braking can thus be independently controlled by its same-side armrest position. This permits independent use of momentary slight wheel braking to retard progress of that respective left or right wheel and assist steering during ambulation. Also on left and right armrests 9a,b, crankshaft axles 37b are shown now swung to the rear, releasing their respective, redundantly dual seat-height brakes (not shown). Note that seat-height unlocking can also be independently actuated for a different reason—so that either armrest, in either seated or ambulating positions (FIGS. 9A and 9C, respectively) can effectively stop the seat from rising or falling; and both armrests must be positioned in the extended-to-the-side position shown here to release seat height lock, so that when boarding the saddle, or rising from a seated position, or merely selecting a new intermediate seat position such as ‘bar-stool’ height, seat/saddle 6 is free to raise and lower the equipoised occupant with minimal effort. FIG. 9C shows the positions of actuating crankshaft arms associated with crankshaft axles 37ab when both armrests are swung forward into the ambulating position. Note that crankshaft arms associated with crankshaft axles 37a are now inward, releasing their respective wheel-brake cables. Crankshaft arms associate with crankshaft axles 37b are respectively outward, engaging their individual seat-height locks so that ambulation is accomplished without having the saddle sink down if both feet are momentarily off the floor during, for example, coasting, or if relaxing in a high stationary position, such as at bar-stool height, with both feet on optional footrests (not shown). Note that the uneven-parallelogram deployment of the armrests is initiated by appropriately arcuate arm motions that mimic the arcuate excursion of parallelogram struts 11ab.

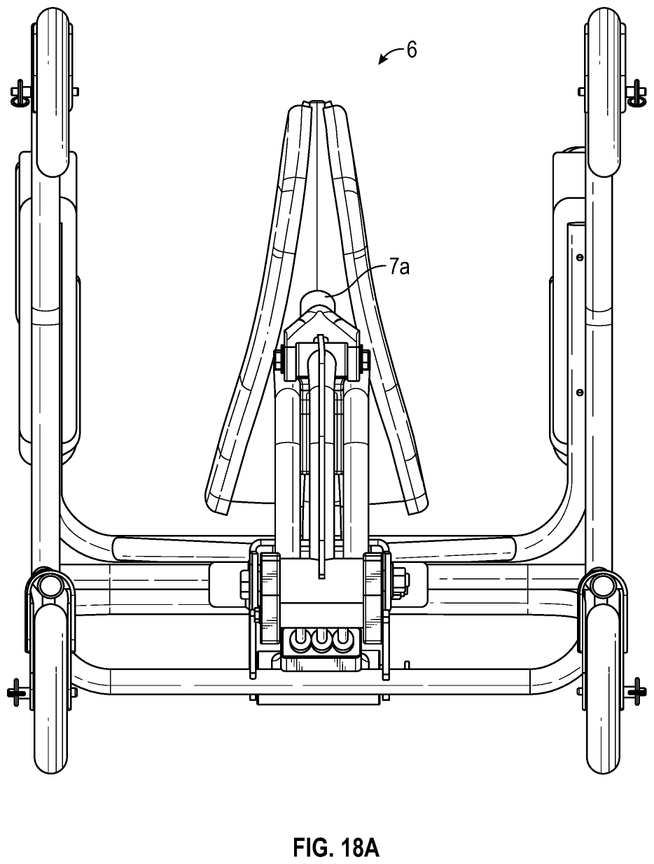

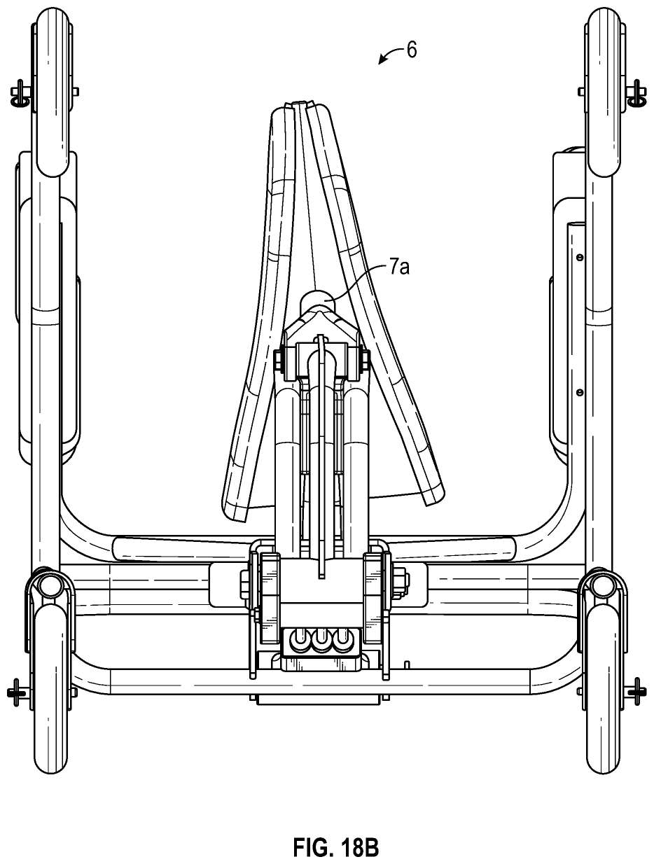

FIG. 10 depicts folding seat/saddle 6 assembly with wing 6a and seat mounting block 7 rendered transparent to show how seat mounting post 7a, rotating within seat mounting block 7 can facilitate limited dynamic side-to-side swiveling of seat/saddle 6 in order to clear a path for the occupant's rearwardly striding thighs. The novel seat-swiveling structure effectively narrows the rear width of seat 6 during vigorous ambulation, since the alternate thigh is unobstructedly heading forward as the other is swinging straight rearward in the clear path created by swinging the triangular aft end of seat 6 out of the way. FIGS. 18A-B show successive underside views of folded saddle/seat 6 as it swivels around the axis of seat post 7 to create an alternately unobstructed rearward path to either side. Seat 6 is preferably adapted to swivel up to at least 15° to either side during ambulation so the wider, rear portion of the saddle moves away from the leg path and the side edge of the saddle that the impelling leg is contacting becomes parallel to the fore-aft axis of the elevating walker chair. Bumpers (not shown) or stops or merely the sides of the folded down seat wings 6a,b can limit the degree of seat rotation.

FIGS. 11A-B depict saddle/seat 6 in unfolded and folded positions, respectively, and show how seat wing 6b is swung upward by telescoping wing deployment strut 38 into seat mode as the saddle descends. Two such identical struts can be employed to simultaneously raise both seat wings 6a,b, but only the right-hand strut 38 is shown here for clarity. FIG. 11A shows an attachment mechanism that includes ball joint 39 of the upper (inner) telescoped segment of strut 38 to the underside of seat side wing 6b. FIG. 11B shows how the lower, outer section of strut 38 attaches by means of ball joint 39 and a short stand-off tube to a lower portion of parallelogram lifting strut 4, so that it has a clear path upward to wing 6b during the phases of seat deployment. Note that telescoping tube 38 is fully extended when saddle 6 is raised up with wing 6b folded down. Strut 38 only begins to raise wing 6b when its telescopic travel is fully retracted, as seat 6 approaches the bottom of its deployment into seat mode, as illustrated by comparison in FIGS. 11A-B.

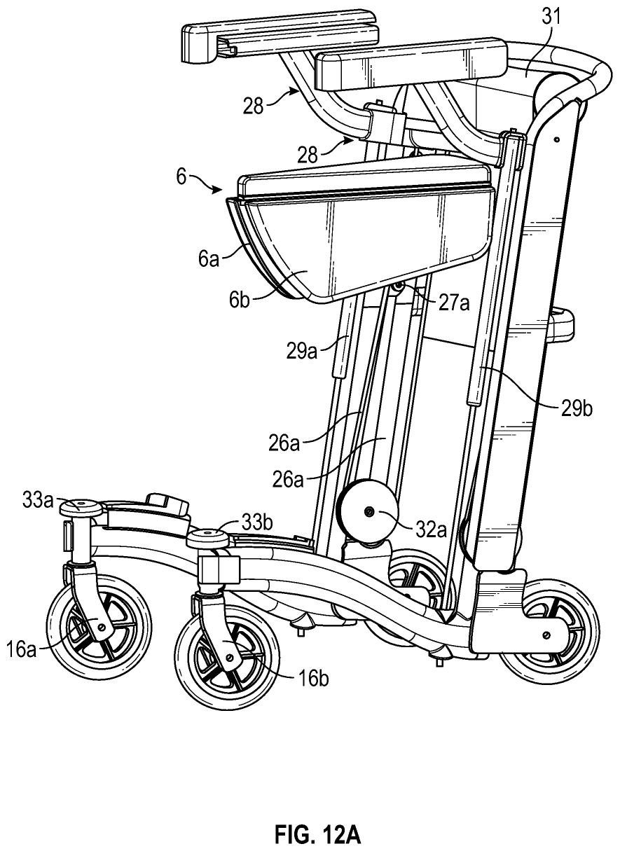

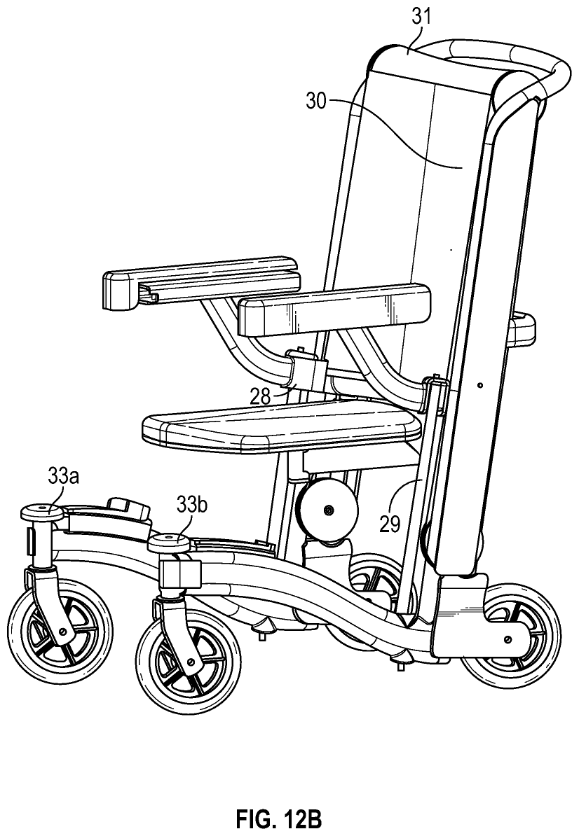

FIGS. 12A-B, 32 depict an alternate embodiment of the elevating walker chair that lifts and lowers seat carriage assembly 28 between walking and seat heights by means of left/right resilient component 29a,b and linear bearing assemblies 27a,b. FIG. 12A shows seat 6 up in saddle mode, with resilient component 29b (gas springs, for example) fully extended to cause seat carriage assembly 28 to rise up by means of left/right linear bearing assemblies 27a,b, and cause roller backrest fabric or covering 30 to retract up and over backrest roller assembly 31, tensioned by left/right backrest tensioning pulley assemblies 32a,b. The force of resilient components 29a,b, such as springs and gas springs, declines linearly as they extend and retract. As used here, to exert force straight along left/right linear bearing track pairs 26a,b, they are not entirely ‘iso-elastic’ and will lift most strongly when fully compressed (or extended in the case of tensile resilient components). Consequently, the linearly powered embodiment of FIGS. 12A-B is suitable for user's who retain some leg strength and can supply the missing lifting power as seat 6 approaches the top of travel. FIG. 12B shows gas springs 29a,b fully compressed as seat carriage 28 reaches the bottom of linear bearing travel and roller backrest fabric 30 is extended and ready for use. Left/right foot-operated caster steering footplates 33a,b are fixedly associated with the swiveling axles of front swivel casters 16a,b and function as dynamic footrests that also help facilitate a form of sociable ‘pushing’ of the elevated chair, in which the occupant is up at eye-height or so with the attending person, who may easily push, for instance, the arm-rest (rather than necessarily rearward handles), and the footplates enable the rider to ‘steer’ by selectively rotating a caster to cause the chair to follow a desired path. An unaccompanied rider can also continue to ‘stride’ with one leg (skateboard style) and steer with the other, in order to progress in a precise direction, such as through a narrow doorway, and steering linkages between castors or elaborate steering geometry may not be required when only one castor is steered by this method.

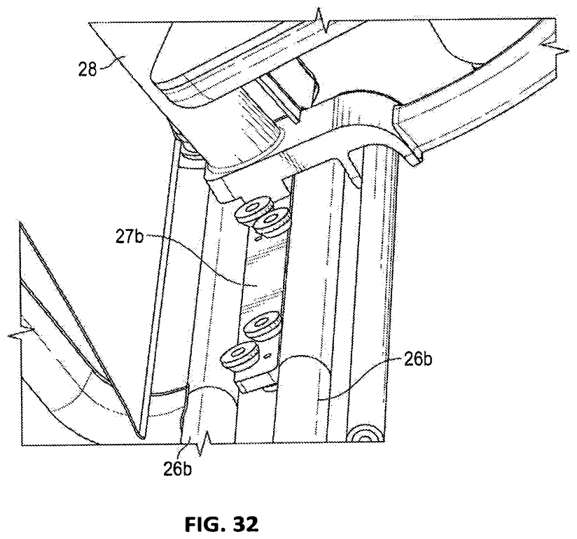

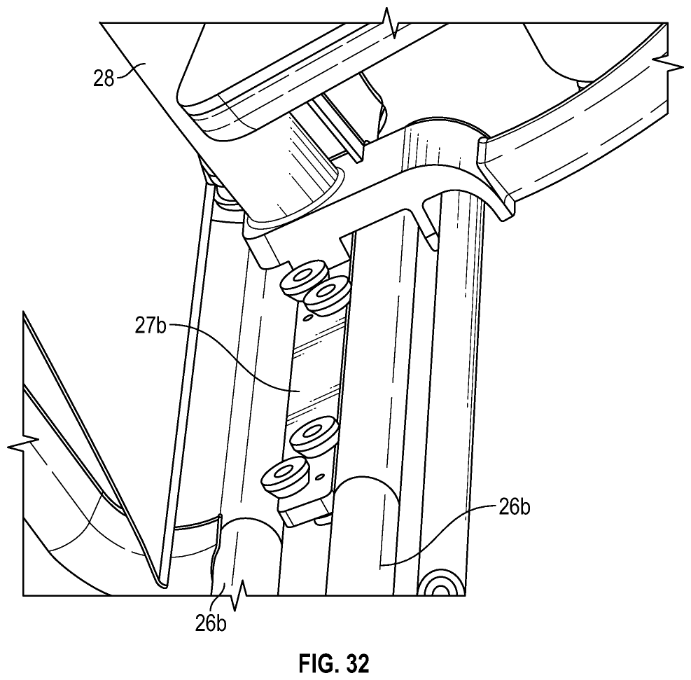

FIG. 32 is an isometric view of one of two linear bearing assemblies 27a,b running between left/right linear bearing track pairs 26a,b, to raise and lower seat carriage assembly 28, to which can also be attached seat 6, actuating armrest assemblies 9a,b, and roller backrest fabric 30. Linear bearing assemblies 27a,b function by means of tapered rollers mounted to be held in contact with opposing linear bearing track pairs 26a,b.

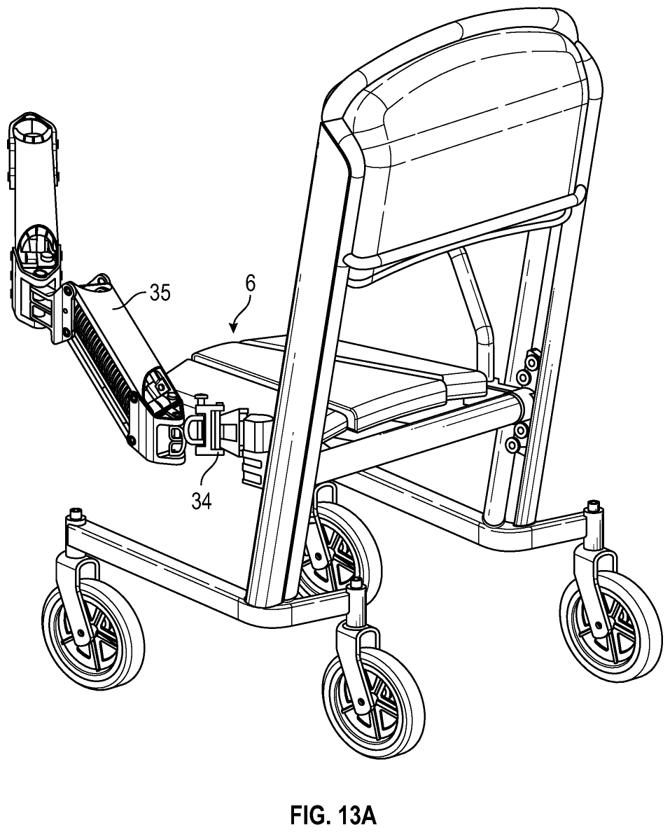

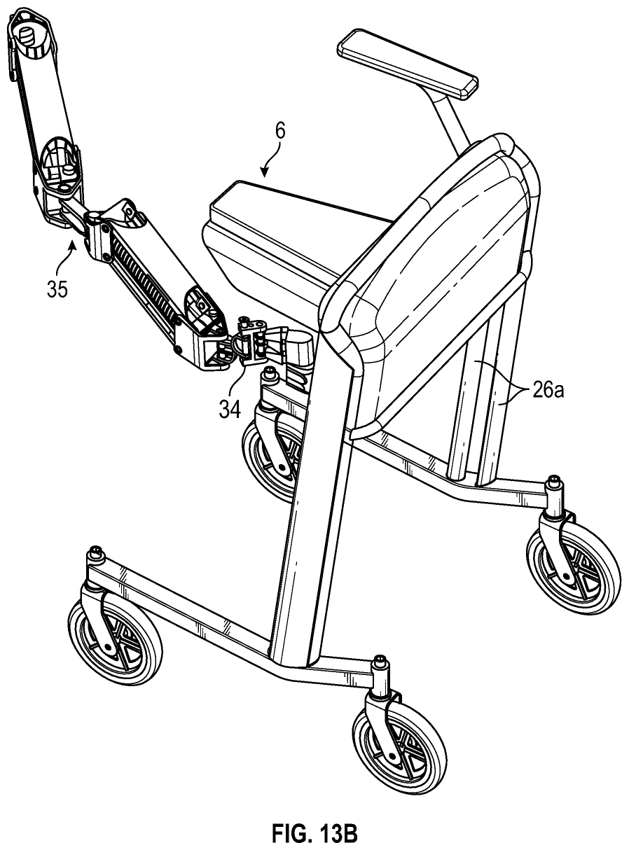

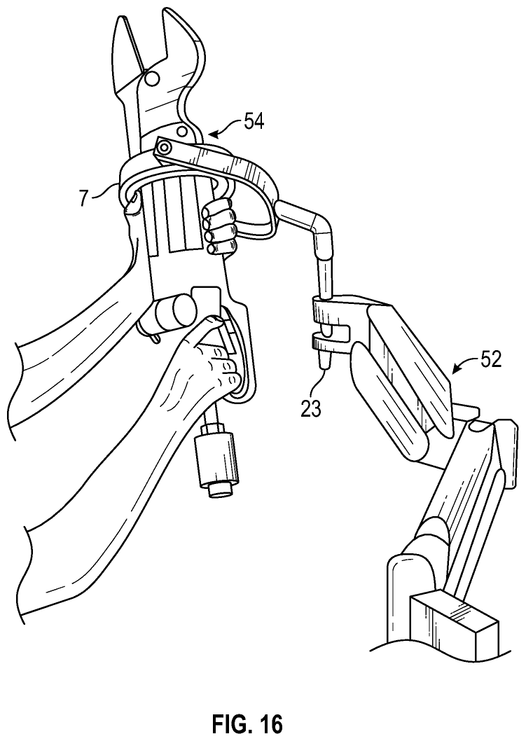

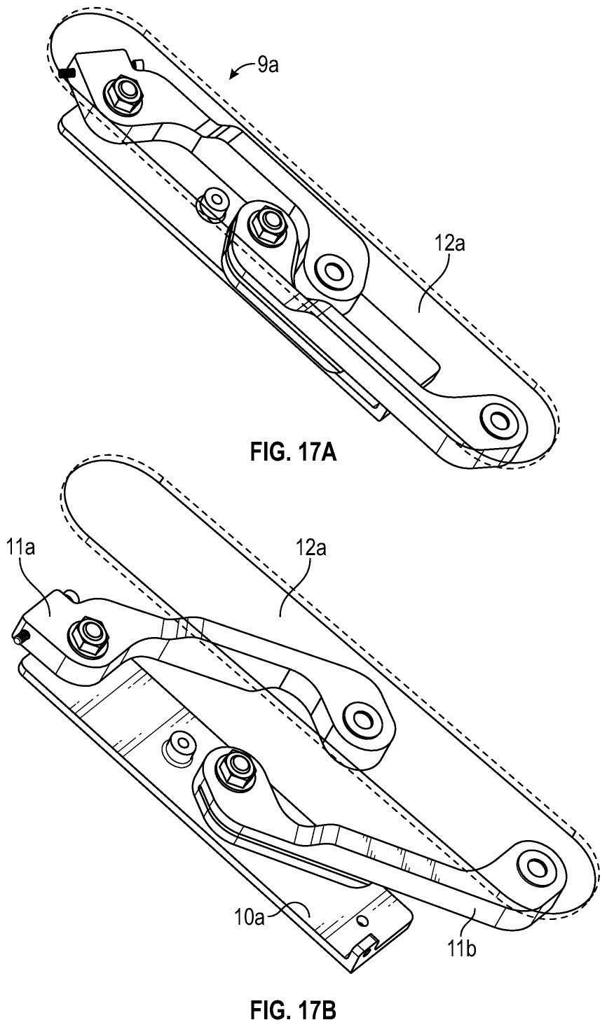

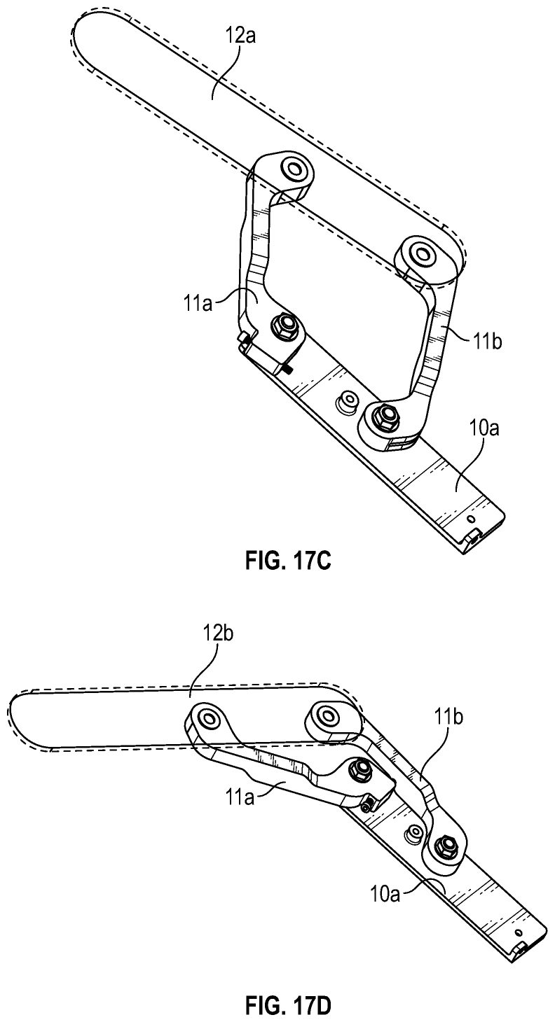

FIGS. 13A-B depict low (seat) and elevated (saddle) deployments, respectively, of an illustrative embodiment of an elevating walker chair that provides support for the combined weight of a user (not shown), a resiliently powered payload support arm 35 such as the ‘Zero-G™ support arms marketed by Equipois, LLC, or other counterbalancing or equipoising arms, and a preferably gimbaled industrial payload, such as shown in FIG. 16. FIG. 16 depicts an illustrative articulated arm 52 and a gimballed tool holder 54. Other tool holders and arms may be used as appropriate for particular application, whether industrial or to provide individuals assistance with everyday tasks. FIGS. 13A-B depict lifting articulated arms with two lifting links each. Each link is of a parallelogram configuration with a resilient member to provide the lifting force. The aforementioned arms may have one or more lifting links. Attached to the distal end of the lifting arm may be a hand or armrest that would leave a user's hands free to perform a task, while being supported by the rest that is attached to the lifting arm. This embodiment of the elevating walker chair can assist deployment of heavy tools in an industrial setting which otherwise might cause, for instance, shoulder injuries from the repetitive strain of holding them outstretched for hours of work. An industrial worker can raise himself plus the arm and tool payload to ‘saddle’ height for relatively easy ambulation between workplace opportunities and repeatedly lower to seat height and rise back up again, depending on the altitude of any particular task.

Particular embodiments or applications of the elevating walker chair may need to more perfectly equipoise both user and payload, and may therefore utilize the “iso-elastic” parallelogram powered embodiment illustrated in FIG. 1, with which an occupant might readily perform ‘pick and place’ (otherwise called ‘material handling’) operations. Such an elevating walker chair would preferably be configured to allow heavy items to be picked up and transported with little effort and little risk of injury, by lowering a worker to chair height, engaging the arm with the payload, rising up with minimal leg effort, maneuvering the payload to its resting place, and sinking down to unload the arm (which may be conveniently restrained at any selected maximum height). This procedure displaces the weight of the transported payload from the hands to the much more powerful thighs and calves, and ‘floats’ the worker's own weight throughout the ‘pick and place’ operation.

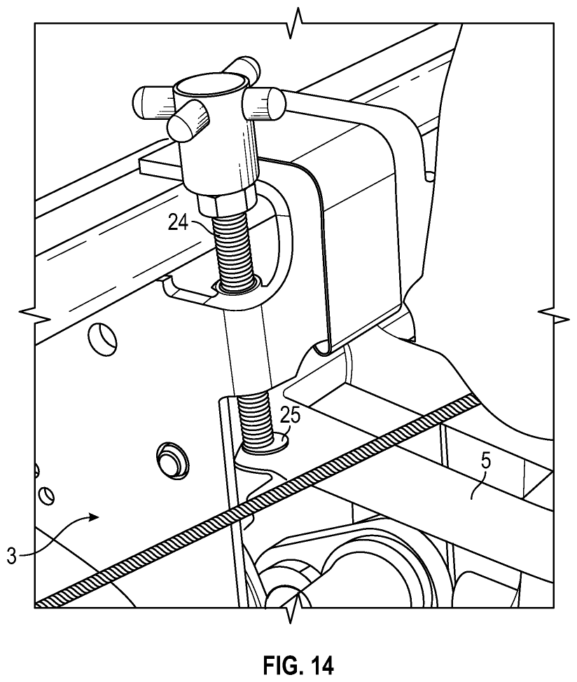

FIG. 14 depicts maximum height adjusting screw 24 and striker plate 25 functioning to restrain one of upper parallelogram struts 5a,b in order to set maximum saddle height as appropriate for the user's inseam measurement, and to ensure that height saddle/seat 6 is appropriately restrained to ease his or her ‘get aboard’ transition from an adjacent unsupported standing position—as well as to set the optimum saddle height for ambulation.

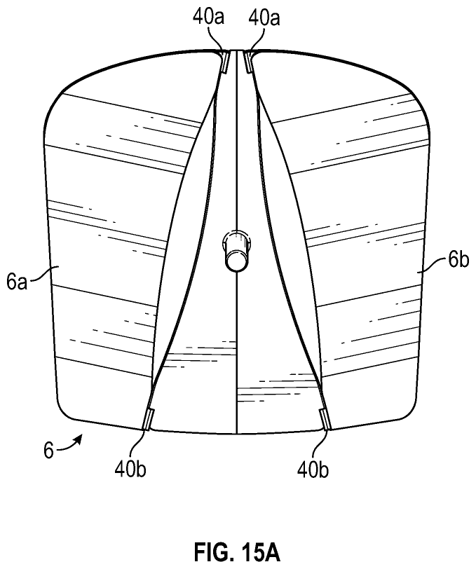

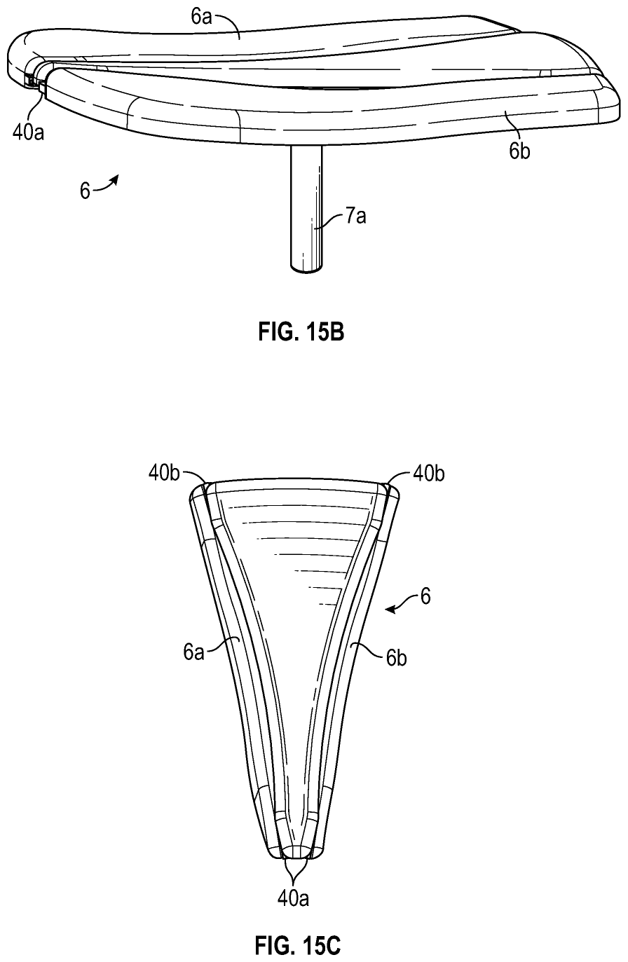

FIGS. 15A-C depict an illustrative embodiment of folding seat/saddle 6 that is curved to be ergonomically compatible with the human form in both the unfolded ‘seat’ mode and the folded ‘saddle’ mode, and that provides the narrowness forward appropriate for male riders and the somewhat increased width slightly farther aft that is generally more comfortable for women. FIG. 15A is an underside view that shows seat folding relief cut-outs 41a,b that permit the slightly curved plane of seat 6, including wings 6a,b and the central triangular portion to join closely together when folded, yet still preserve optimal narrowness at the forward area as a saddle. Shown are fore/aft hinge sets 40a,b, configured in a v-pattern to fold into a pointed saddle-shape approximately an inch wide in front and 6 inches wide at the rear. Fore and aft components of hinge sets 40a,b are positioned in line with each other but interrupted in between by left and right folding seat relief cut-outs 41a,b. FIG. 15B shows the extremely shallow curve imposed on the entire unfolded top surface of seat 6, as if it were cut from a cylindrical section of extremely large radius. The result of this large-radius, ‘master’ curvature and cut-outs 41a,b, in combination with hinge sets 40a,b, is an upholstered shape that, in FIG. 15C can be seen to fold into a saddle shape of exemplary narrowness. Upholstery materials, such as gel sections and elastic covering materials are preferably used so seat 6 remains narrow but is comfortably padded, when folded into a saddle, as well as when unfolded into a seat. Non-upholstered saddles are also an option.

The topology of this master curve compounds when folded and helps prevent bulging of upholstery when unfolded, as the radius of folding has not increased as much as it would around intact straight hinge lines. Excess material can ‘cut the corner’ and be drawn inward into the cut-out gaps when folded and resiliently released when unfolded. Strong flexible outer covering material will also help ensure that a rider's clothing is not pinched by the sides of cut-outs 41a,b as they close together. Note that as the radius of the master curvature decreases, and the width of folding relief cut-outs 41a,b increases, the folded saddle becomes progressively narrower.

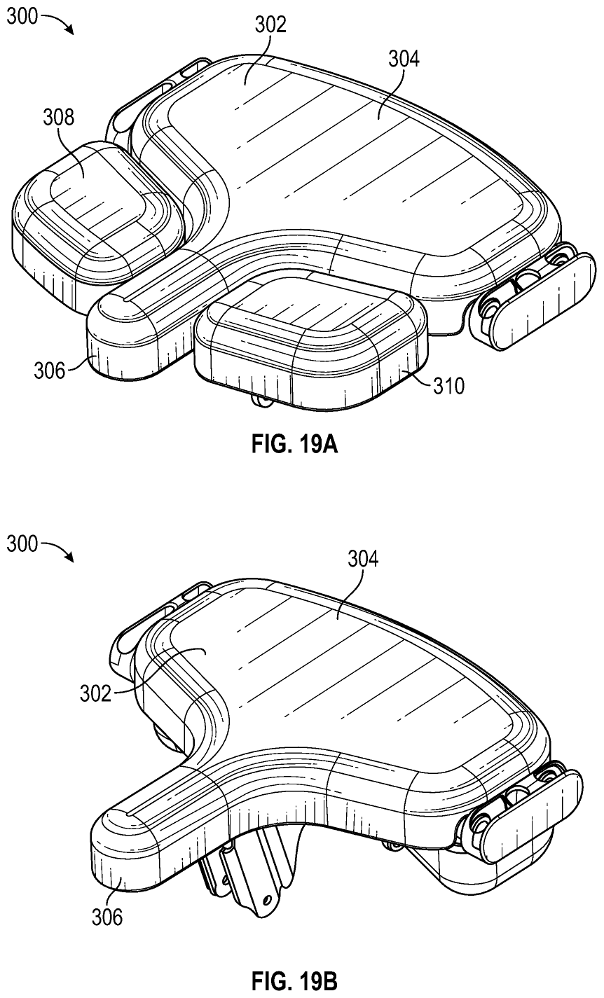

FIGS. 19A-B depict a further illustrative embodiment of a convertible seat 300 that transforms from a chair configuration or mode to a saddle configuration or mode. FIG. 19A depicts convertible seat 300 in the chair configuration. Thigh sections 308, 310 are movably attached to saddle section 302, such as by one or more hinges. In the chair mode thigh sections 308, 310 extend from saddle section 302 to form a sitting surface. The sitting surface may be substantially flat or contoured. In general supports a user in a sitting position in a manner analogous to that of a chair. Saddle section 302 has a rear portion 304 with a narrower front portion 306 extending from rear portion 302. Thus, as shown in FIG. 19B, when thigh sections 308, 310 are folded rearward with respect to saddle section 302 the apparatus forms a saddle configuration. Armrest mounts 301 are optionally included to attach armrests, such as 9a,b shown in FIG. 1, or conventional armrests such as for example, those typically present on wheelchairs. The configuration and positioning of armrest mounts 301 will depend on the particular type of armrest employed.

Although right and left thigh sections 308, 310 are depicted as separate components, they may be joined as a single thigh section spanning both right and left sides of front section 306, provided they can fold away from the sides of front portion 306 to form a saddle.

Convertible seat 300 may be used in an elevating walker chair or other apparatus where conversion from a seat configuration to a saddle would be desired. Convertible seat 300 may be used in any of the elevating walker chairs disclosed herein.

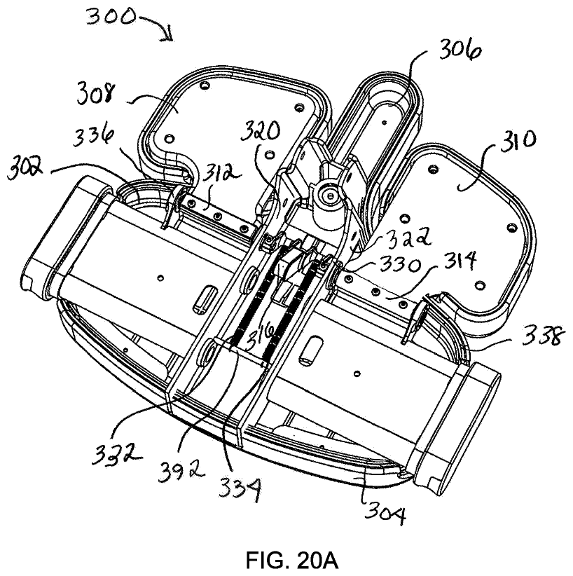

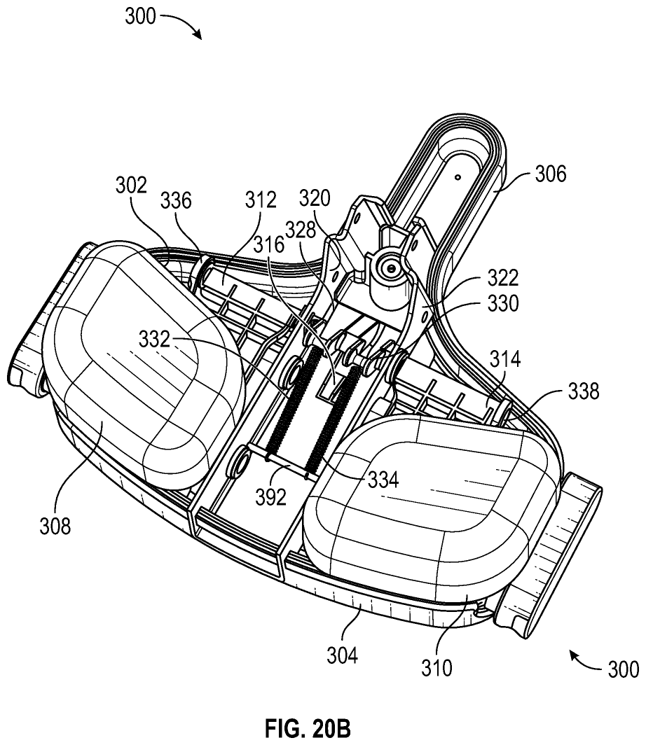

FIGS. 20A-B depict the underside of convertible seat 300 in a seat mode and saddle mode, respectively. Right thigh section 38 and left thigh section 310 are hinged to saddle section 302 either directly or indirectly at right thigh section hinge 312 and left thigh section hinge 314, respectively. Bell cranks 328, 330 are disposed between seat support walls 320, 322 and are functionally connected to shafts 336, 338 of thigh section hinges 312, 314 so that motion of bell cranks 328, 330 causes thigh sections 308, 310 to rotate about shafts 336, 338.

Cam 316 is fixed between bell cranks 328, 330. Springs 332, 334 extend from bell cranks 328, 330, respectively, to spring axle 392. As will be described in more detail below, cam 316, bell cranks 328, 330 and seat deployment springs 332, 334 are part of a seat deployment mechanism that biases thigh sections 308, 310 to either a folded position as shown in FIG. 20B or an extended (unfolded) position as shown in FIG. 20A. Although parts 332, 334 are shown as springs, other types of resilient members may be used, provided they are compatible with the use and function of seat deployment mechanism 346.

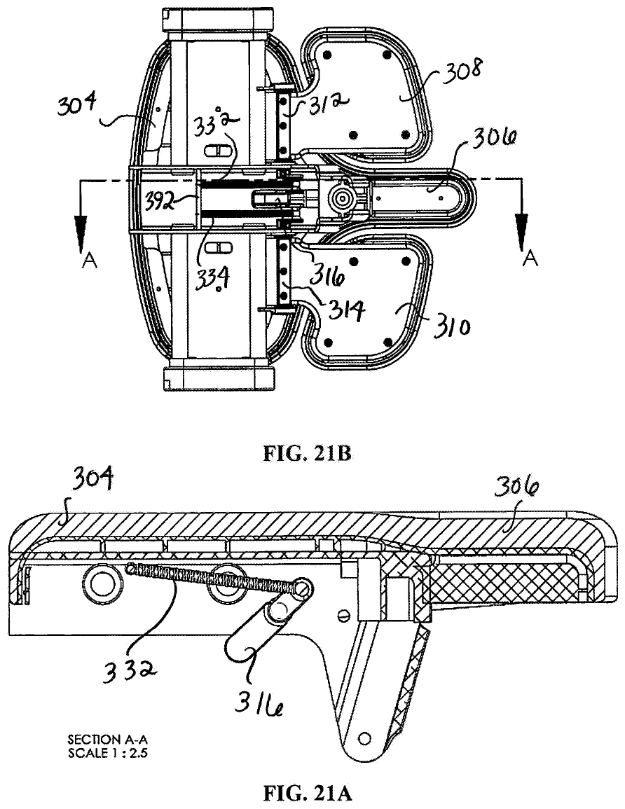

FIG. 21A is a cross-sectional view taken through A-A of FIG. 21B. FIGS. 21A-B show thigh sections 308, 310 deployed to form a seat structure. FIG. 21A shows cam 316 extended toward the front of convertible seat 300, which allows thigh sections 308, 310 to be deployed in a seat configuration. Returning to FIG. 21A, it can be seen that when the end of cam 316 attached, either directly or indirectly, to bell cranks 328, 330, and thus seat deployment springs 332, 334, is rotated toward the front of convertible seat 300, seat deployment springs 332, 334 are extended, as thigh section 308, 310 rotate upward to form a seat.

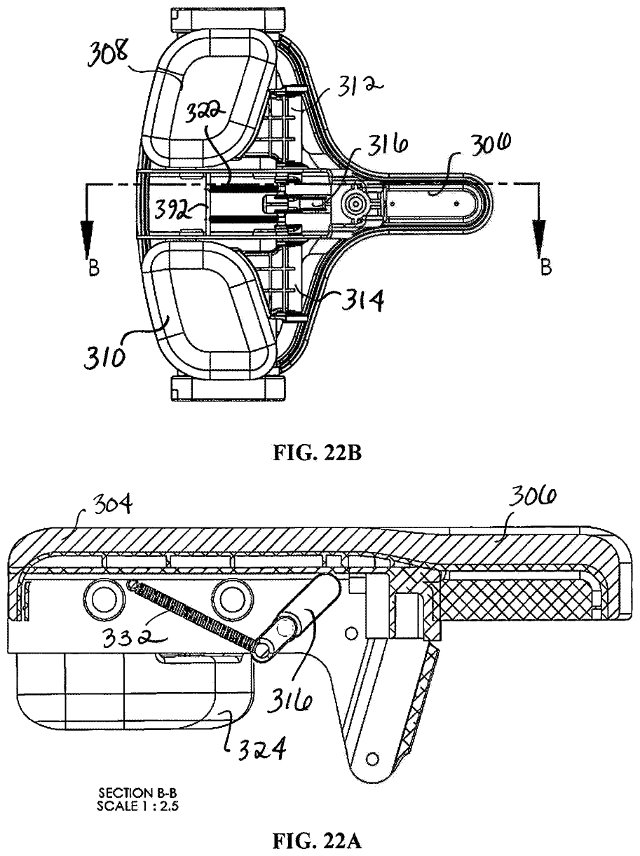

FIG. 22A is a cross-sectional view taken through B-B of FIG. 22B. FIGS. 22A, 22B show thigh sections 308, 310 rotated to a saddle position. FIG. 22A shows cam 316 rotated toward the rear of convertible seat 300, which causes thigh sections 308, 310 to be rotated downward from saddle front portion 306 to form a saddle structure. Seat deployment springs 332, 334 are compressed as compared to when convertible seat 300 is in a seat position. To provide sufficient clearance for a user's legs in a walking motion, thigh sections 308, 310 can rotate toward the rear of convertible seat 300.

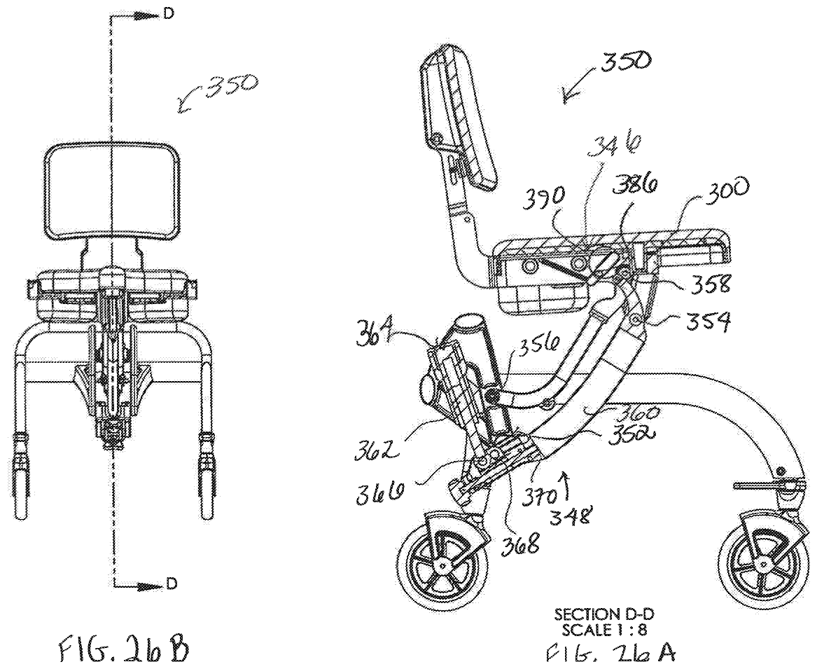

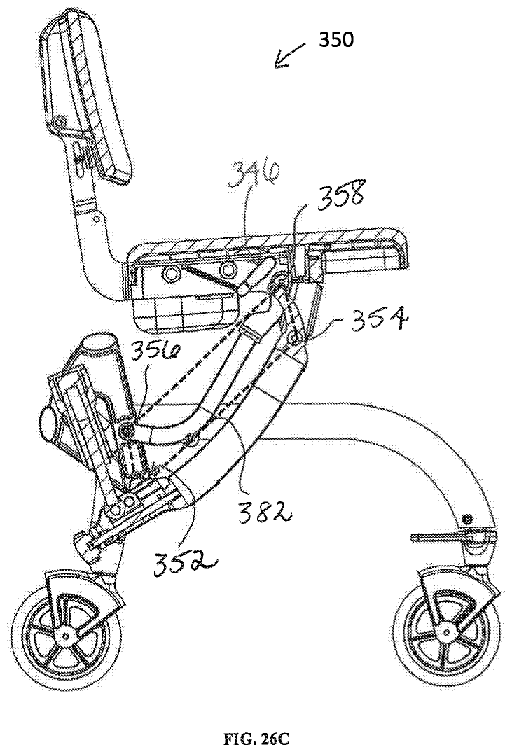

FIG. 23A is a cross-sectional side view taken through C-C of FIG. 23B. FIGS. 23A-B depict a side view of an elevating walker chair 350. Elevating walker chair 350 is in a lowered position with thigh sections 308, 310 deployed forwardly to a seat position. Seat deployment mechanism 346 transforms convertible seat 300 between a seat mode when in a lowered position and a saddle mode when in an elevated position, such as shown in FIG. 26A. Seat deployment mechanism 346 is functionally connected to a lifting mechanism 348 that elevates and lowers elevating walker chair 350. Lifting mechanism 348 can be employed in place of the lifting mechanism shown in FIGS. 5A-5B, for example. Any lifting mechanism that can raise and lower the seat/saddle of the elevating lifting chair and also be functionally coordinated with a seat deployment mechanism to transform a convertible seat from a seat to a saddle and vice versa, can be used in the disclosed embodiments of the elevating walker chair. Lifting mechanism 348 will now be described followed by seat deployment mechanism 346 and the relationship between the two mechanisms.

Lifting mechanism 348 of elevating walker chair 350 includes a parallelogram structure defined by pivots 352, 354, 356, 358. Lower parallelogram link 360 extends between main pivot 352 and pivot 354. In the illustrative embodiment of FIG. 23A, lower parallelogram link 360 has an extension frame 370 in fixed relationship to it. Main pivot 352 allows lower parallelogram link 360, together with extension frame 370, to rotate with respect to the frame of elevating walker chair 350 to which it is attached.

As used herein, “parallelogram” and “parallelogram structure” refer to a structure containing four pivot points wherein components pivoting about those points move in unison in a somewhat fixed angular relation in the manner that component parts of traditional parallelogram would. The terms are not restricted to the pivoting components being linear, and thus not necessarily parallel or equal in length.

Extension frame 370 provides components for adjustability of lifting mechanism 348. Lifting mechanism can be adjusted for effective force to accommodate users of different weights and abilities. A lifting spring 362 extends from upper spring pivot 364 to a lifting spring termination pivot 366. Lifting spring termination pivot 366 is adjustable along slot 368. As lifting spring 362 expands, it causes rotation of lower parallelogram link 360 about main pivot 352, which in turn lifts seat 300. Lifting mechanism 348 may be adjustable, such as by the adjustable spring termination mechanism depicted in FIG. 23A or by other mechanisms, or it may be non-adjustable. Although part 362 is shown as a spring, other types of resilient members may be used, provided they are compatible with the use and function of lifting mechanism 348.

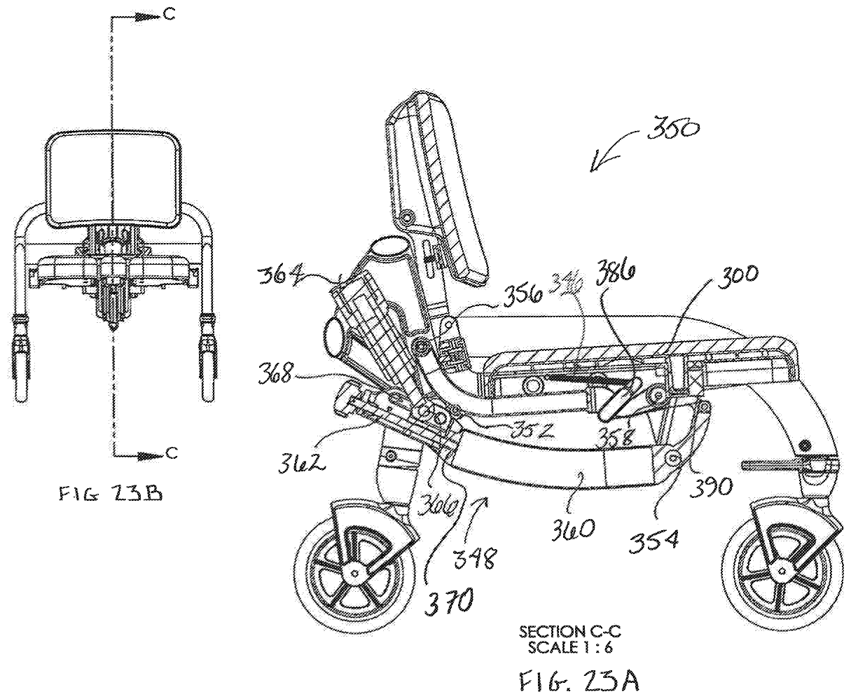

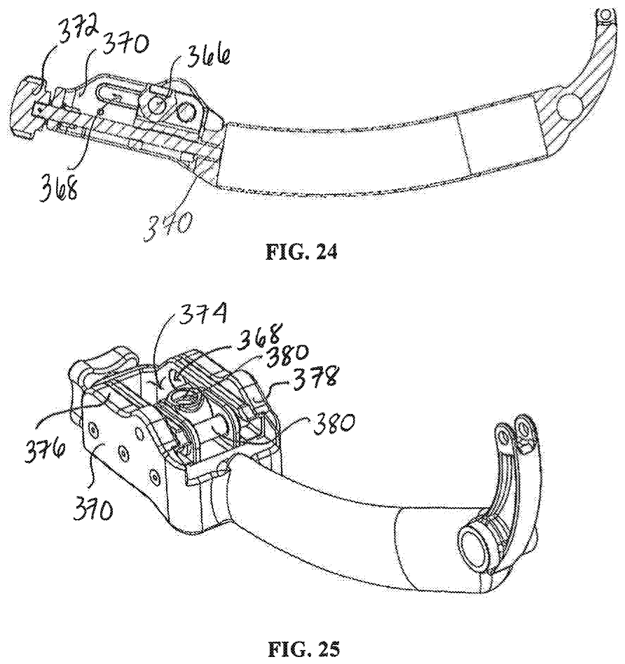

FIG. 24 shows an enlargement of extension frame 370 in which lifting spring termination pivot 366 is engaged with slot 368 in a relatively “weak” position because the lever arm created by extension frame 370 between termination pivot 366 and main pivot 352 is at its shortest. See FIG. 23A for the relative positions of termination pivot 366 and main pivot 352 The position of lifting spring termination pivot 366 in slot 368 can be adjusted by driving screw 372.

FIG. 25 depicts a car 374 of lifting mechanism 348, which is an interior component of extension frame 370 in this illustrative embodiment. Car 374 moves between car walls 376, 378 to allow lifting spring termination pivot 366 to move along slot 368. Idler roller 380 stabilizes car 374 to prevent or inhibit tilting about lifting spring termination pivot 366.

Spring receptacle 381 accommodates lifting spring 362. In the embodiment depicted in FIG. 25, spring receptacle 381 is shown as an opening into which a component of lifting spring 362 is inserted. Other lifting spring connection mechanisms may be used, provided that they allow for the operation of lifting mechanism 348 and are durable enough to withstand resultant forces.

FIG. 26A is a cross-sectional side view taken through D-D of FIG. 26B. FIG. 26B is a front view of elevating lifting chair 350. FIGS. 26A, 26C depict a side view of an elevating walker chair 350. A parallelogram 382 of lifting mechanism 348, is defined by pivots 352, 354, 356, 358, and is shown by dotted lines in FIG. 26C. Convertible seat 300, or a component to which it is attached, is in fixed relation to parallelogram 382. The parallelogram link between pivots 352, 356 remains in fixed angular relation to horizontal as seat 300 is elevated or lowered. Saddle section 302 of seat 300 is in fixed angular relation to the parallelogram link connecting pivots 352, 356. Therefore, as seat saddle section 302 is elevated or lowered it remains at its fixed position with respect to the horizon. Generally, seat 300 will be substantially level or at a selected angle to the horizontal. Note that convertible seat 300 need not be horizontal, but may be fixed at other angular positions to the horizontal, and may be adjustable as to that angle.

The longitudinal line of slot 368 does not necessarily coincide with the momentary lever arm between main pivot 352 and spring termination pivot 366.

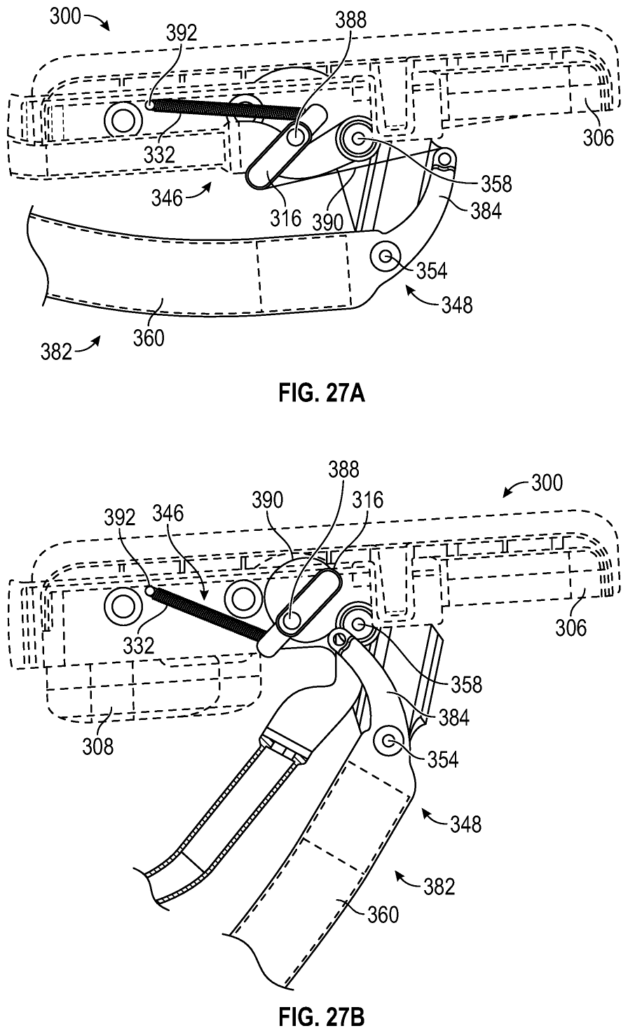

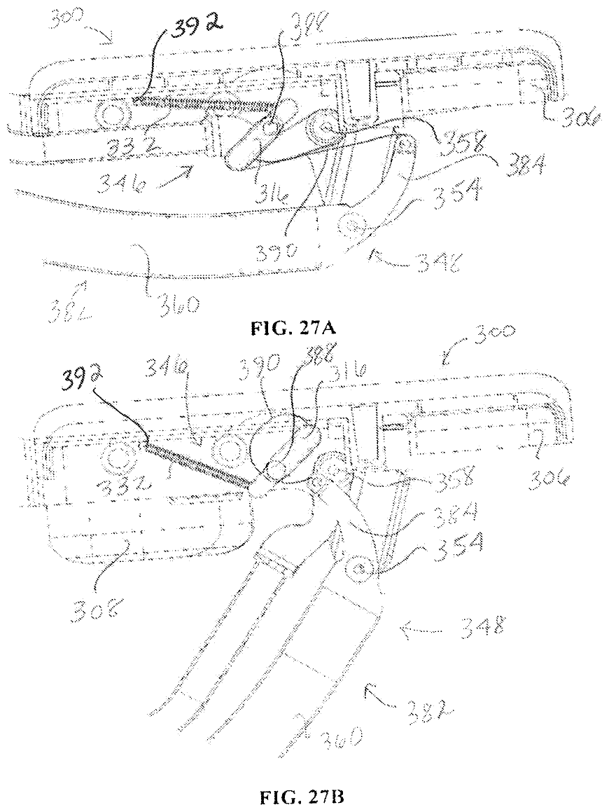

FIGS. 27A-B depict convertible seat 300 with seat deployment mechanism 346 connected to parallelogram 382 (partially shown), in lowered and elevated positions, respectively. FIG. 27A depicts seat deployment mechanism 346 connected to a portion of lifting mechanism 348 when elevating walker chair 350 is in a lowered position with thigh sections 308, 310 in a seat configuration. The portion of lifting mechanism 348 shown includes lower parallelogram link 360, and pivots 354, 358. Also shown is a wiper arm 384 that is attached to and extends beyond lower parallelogram link 360. Seat deployment mechanism 346 is functionally connected to lifting mechanism 348 by means of wiper arm 384, and therefore, is acted upon when the angles of parallelogram 382 are modified, such as by the action of lifting mechanism 348, or more specifically in this embodiment, by lifting spring 362.

Although seat deployment mechanism 346 is shown engaged with lifting mechanism 348, seat deployment mechanism can be functionally connected to other cam activation mechanisms that act on cam 316 to transform convertible seat 300 between a saddle or seat configuration.

Cam 316 is connected to convertible seat 300 thigh pad axles 336, 338 via bell cranks 328, 330. Alternatively, a single axle can span right thing section 308 and left thigh section 310, with cam 316 attached to that single axle. As such for simplification, right and left thigh pad axles 336, 338 shall also mean right and left thigh pad axle sections 336, 338.

First ends of each of seat deployment springs 332, 334 are fixed to spring axle 392. Spring axle 392 is fixed to convertible seat 300. Second ends of seat deployment springs 332, 334 are fixed to bell cranks 328, 330 (shown in FIGS. 20A, B), which are attached in line with thigh pad axles 336, 338 of thigh section pivots 388. Seat deployment springs 332, 334 are shown as extension springs. Various types of spring members may be employed. A cam belt 390 has a first end attached to wiper arm 384 and a second end fixed to cam 316. Cam belt 390 may comprise a material such as steel-reinforced polyester. It may be an elastic but stretch-resistant material, for example. Cam belt 390 is generally an elongated, flexible component, and may be for example, a line, cord, wire, belt or cable.

FIG. 27B depicts seat deployment mechanism 346 connected to a portion of lifting mechanism 348 when elevating walker chair 350 is in an elevated position with thigh sections 308, 310 in a saddle configuration. As convertible seat 300 is elevated, wiper arm 384 rotates toward cam 316 so that the attachment point of cam belt 390 to wiper arm 384 moves closer to the attachment point of cam belt 390 to cam 316 causing cam belt 390 to slacken. Pressure from an occupant's thighs on thigh sections 308, 310 provides a force to push thigh sections 308, 310 downward. The force of seat deployment springs 332, 334 on bell cranks, 328, 330 (shown in FIGS. 20A, B), and thus on cam 316, rotates cam 316, for example by 180 degrees or so, causing thigh sections 308, 310 to flip to the rear of convertible seat 300, thereby creating a saddle configuration.

Similarly, when an occupant begins to sit on convertible seat 300 when in a saddle position, force from the occupant's weight lowers convertible seat 300. As convertible seat 300 descends, cam belt 390 tightens, thereby, tensioning cam 316 to rotate forward, or counterclockwise in this illustration, and in turn, expanding seat deployment springs 332, 334. This allows thigh sections 308, 310 to rotate forward to form a seat. In an exemplary embodiment, belt 390 becomes taut and thigh sections 308, 310 are deployed at 8 inches from the lowest seat position. An illustrative range of thigh section deployment height is 6 inches to 10 inches above the final seat height. An illustrative seat height for the sitting position is a standard 18 inch height. The sitting position however may lower or higher than the standard chair seat height. An illustrative range is about 16 inches to 20 inches. This illustrative range and height may be applied to any of the embodiments of the elevating lifting chair.

Lifting mechanism 348 is coordinated with seat deployment mechanism 346 to preferably provide a comfortable and safe transition between the seat and saddle configurations of convertible seat 300 while elevating walker chair 350 is lowered or raised.

Many lifting systems are iso-elastic, in other words, they counteract the constant force of gravity on the payload to balance it and provide even lifting power throughout the vertical excursion. In an illustrative embodiment of elevating walker chair 350 and lifting mechanism 348, the elasticity is not uniform throughout the excursion of the lifted or lowered seat. Instead, the force varies to afford the desired deployment force at selected times or heights. The power of lifting mechanism 348 diminishes slightly at the very bottom of travel, so descending momentum is available to help power seat deployment. The most suitable geometry to provide the most beneficial user experience will depend on various aspects of the geometry of lifting mechanism 348, user weight and other chair characteristics. The term “payload” as used herein includes the occupant and components of elevating walker chair 350 that provide force to counteract the force of lifting spring 362. The term “occupant” may also be used in places interchangeably with “payload” or “user.”

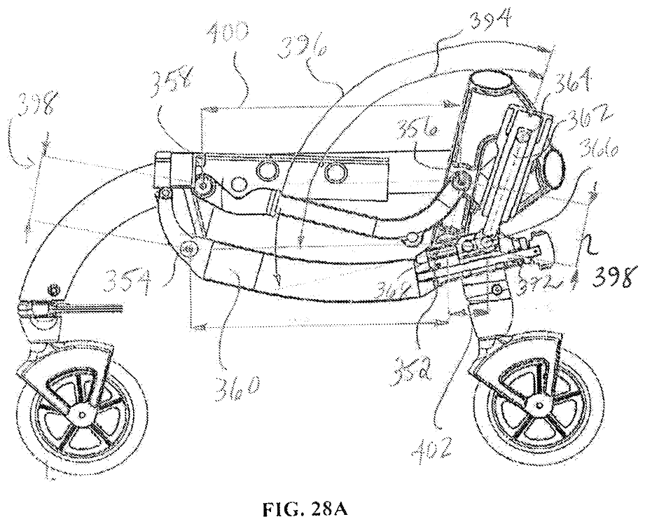

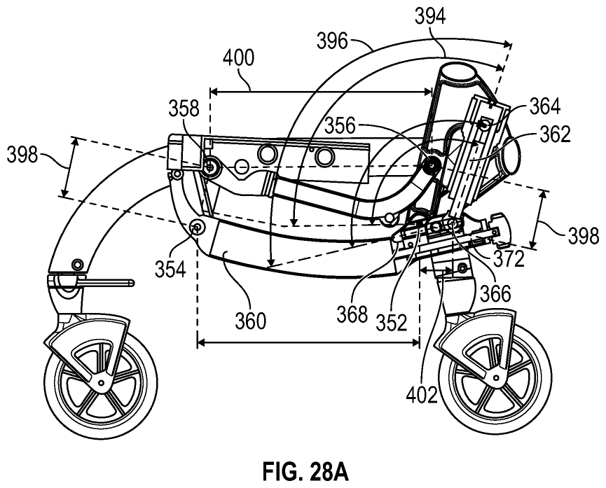

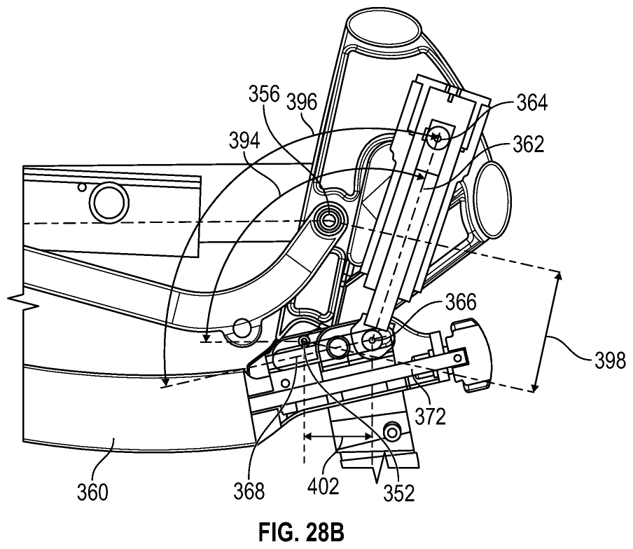

FIGS. 28A-B, 29A-B depict illustrative specifications that affect forces and user experience at different vertical levels and different positions of lifting spring termination pivot 366 in slot 368. For clarity, the following two different types of spring components are noted: seat deployment springs 332, 334 and lifting spring 362. Seat deployment springs 332, 334 act to transform or help transform convertible seat 300 between a seat and saddle mode. Lifting spring(s) 362 function to elevate and lower seat 300.

Following is a description of how iso-elasticity or equipoise is obtained and augmented to provide elevating walker chair 350 with an iso-elasticity profile or lifting curve that compensates for the user's weight or a portion of a user's weight that is momentarily supported by the ground. Structure is described that allows the iso-elasticity profile to be adjusted as desired or needed. Although the term “iso-elasticity” is used, it will be understood as described herein that there may be variations in the lifting force through the excursion from a lowered position to an elevated position.

The measurements are taken when the upper and lower links of parallelogram 382 are level, i.e. perpendicular to the direction of gravity. Note that ‘level’ as shown here is above actual seat height. The prevailing angles are illustrated when the parallelogram is level in order to be able to compare various versions.

The measurements include the lifting angle 394, slot angle 396, the distance between parallelogram pivots 354 and 358, or between parallelogram pivots 352 and 356, as these distances are equal to one another, the distance between parallelogram pivots 356 and 358, or between parallelogram pivots 352 and 354, as these distances are equal to one another, and the distance between lifting spring termination pivot 366 and main pivot 352. The distance between parallelogram pivots 354 and 358 or between parallelogram pivots 352 and 356 will be referred to as the parallelogram short link length 398, and the distance between parallelogram pivots 356 and 358 or between parallelogram pivots 352 and 354 will be referred to as parallelogram long link length 400. The distance between lifting spring termination pivot 366 and main pivot 352 will be referred to as the termination pivot distance 402.

Lifting angle 394 is the angle between the line connecting upper lifting spring pivot 364 and lifting spring termination pivot 366 and the line connecting lifting spring termination pivot 366 and main pivot 352. The line between lifting spring termination pivot 366 and main pivot 352 acts as a “virtual lever arm” or “lever arm” on parallelogram 382. Slot angle 396 is the angle between the line connecting upper lifting spring pivot 364 and lifting spring termination pivot 366 and the line along which lifting spring termination pivot 366 can be adjusted in slot 368. Slot angle 396 merely illustrates the potential path of lifting spring termination pivot 366 as the length of the lever arm changes.

Note that when the parallelogram arms are level, as in these illustrations, spring 362 is almost entirely compressed (for this embodiment we specified a 50% progression rate so that the force when extended is half the force when compressed). So for iso-elasticity, the compressed force should be diminished and the extended force augmented as the maximum excursion height is approached, because otherwise, in a non-iso-elastic configuration, the payload would float in the middle and require extra downward force to reach the bottom and added lift to get to the top.

FIG. 28A depicts elevating walker chair 350 in a lowered position toward, but not at the lowest level, with lifting spring termination pivot 366 in the rear-most position of slot 368, i.e. as a relatively long lever arm. FIG. 28B is an enlargement of a portion of FIG. 28A. There are two distinct lifting conditions. When the lever arm is long (for strong lift), a geometry that creates iso-elasticity or near iso-elasticity throughout the excursion is needed, since the entire spring excursion is employed, going from maximum to minimum. In this illustrative embodiment, lifting angle 394 is significantly oblique—an inefficient pushing angle—so that the payload is in balance without additional force to lifting spring 362. In fact, in this embodiment it may be so inefficient that the force actually diminishes slightly as we approach seat height, so as to facilitate seat deployment. Because lifting angle 394 is significantly oblique, i.e. an inefficient pushing angle, the payload is balanced with or without the additional force.

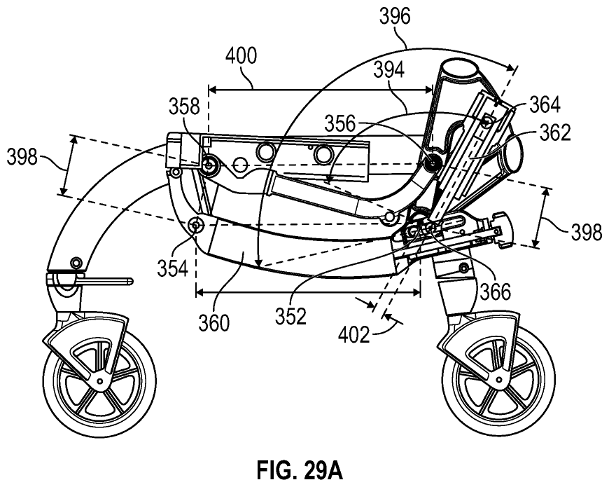

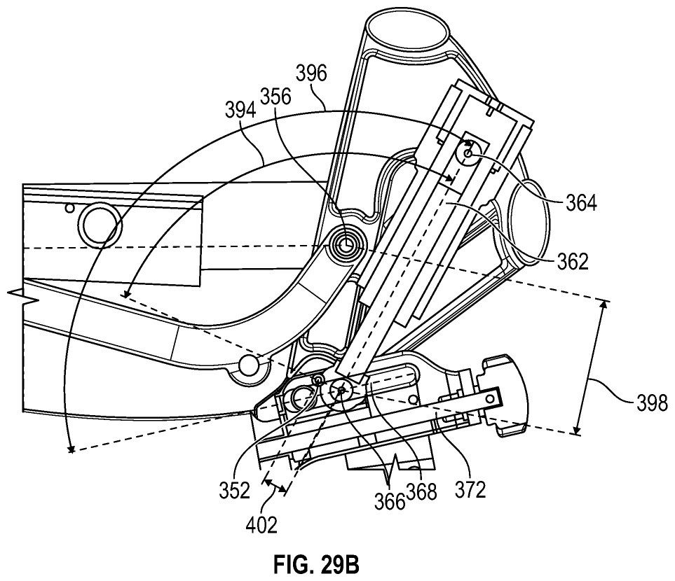

FIG. 29A depicts elevating walker chair 350 in a vertical position toward but not at the lowest level with a smaller termination pivot distance 402, thereby creating a shorter lever arm than is depicted in FIGS. 28A-B. Termination pivot distance 402 can be adjusted, for example, by rotating driving screw 372 (shown in FIG. 29B). Accordingly, the configuration shown in FIGS. 29A-B will provide “lighter” lifting than the structure shown in FIGS. 28A-B.

FIG. 29B is an enlargement of a portion of FIG. 29A. When the lever arm is short (for minimal lift), the iso-elasticity profile may need to be modified by diminishing the resultant change to iso-elasticity to cause it to provide equivalent performance In this illustrative embodiment slot angle 396 is not co-incident with lifting angle 394, so that force efficiency is increased against the shorter lever arm, i.e. termination pivot distance 402. This divergent slot angle counters the inherent change to the iso-elastic profile that occurs with diminished spring travel, i. e. when the spring does have a full excursion from fully compressed to fully expanded. This shorter lever arm only exercises the middle portion of the spring's excursion, but the efficient force angle makes up the difference and allows the spring to provide lift which is as iso-elastic throughout the excursion for a small payload as for a longer lever arm and greater payload, or has a similar iso-elastic profile as for a longer lever arm.

As can be seen by comparing FIGS. 28A-B with FIGS. 29A-B, as slot angle 396 increases, lifting angle 394 decreases. The desired variations in iso-elasticity throughout the lifting excursion, thus, are established by selecting parameters noted, for example, which can be dependent on one another. For example, the optimum lifting angle 394 will vary depending on the selected length of the “lever arm” on which the lifting force is exerted.

FIGS. 30, 31 depict elevating walker chair 350 at a higher level of excursion than is shown in FIGS. 28A, 29A. In the illustrative embodiments of FIGS. 30, 31, upper and lower links of parallelogram 382 are not level.

FIG. 30 depicts spring termination pivot 366 in the rear-most position along slot 368. FIG. 31 depicts spring termination pivot 366 in the positioned in slot 368 further toward the front of elevating walker chair 350. In FIG. 30 lifting angle 394 and slot angle 396 are smaller than when the apparatus is in a lowered position. FIG. 30 shows parallelogram 382 raising convertible seat 300 to its maximum height. In this embodiment, lifting angle 394 has crossed centers (passed below 90°). The force is exerted on the lever arm in this configuration at an angle that provides iso-elastic lift, or near iso-elastic lift, to be sustained all the way to the top of excursion or substantially all the way to the top of excursion.

In FIG. 31 the lifting angle has crossed below 90° and is diminishing in order to counter the small spring progression at the center of travel.

Therefore, the selection of slot angle 396, the location of spring main pivot 352 and the adjustment of lifting spring termination pivot 366 along slot 368 determines, at least in part, the lifting efficiency of lifting spring 362 vs the momentary lifting angle, at any given elevation of the parallelogram arm. An illustrative range of the distance from lifting spring termination pivot 366 and main pivot 352 is 0.7 inches to 2.8 inches. An illustrative usable slot length is in the range of 2.0 inches to 2.5 inches.

Generally, if the aspect ratio of the long and short sides of parallelogram 382 remains the same, the optimum lifting angles with remain the same. An illustrative range of the length of parallelogram short link 398 is 4 inches to 7 inches. An illustrative range of the length of parallelogram long link 400 is 14 inches to 16 inches.

An effective upper lift arm angle is measure from the horizontal to a line through pivots 356, 358, for example. An illustrative range of effective lift arm angle for the elevated position is 40 degrees to 45 degrees. An illustrative range of effective lift arm angle for the lowered position is 11 degrees to 13 degrees.

Table 1 lists illustrative parameter ranges for an elevating walker chair in lowered and raised positions for a parallelogram.

TABLE 1

| | | | SPRING TERMINATION |
|---|---|---|---|
| | | | POINT/PIVOT |
| POSITION | SLOT ANGLE | LIFTING ANGLE | DISTANCE |
| Lowered | 115°-150° | 90°-130° | 0.7″-2.8″ |
| Elevated | 70°-95° | 50°-75° | 0.7″-2.3″ |

Table 2 provides overall illustrative parameters for a parallelogram in lowered and elevated positions with a 4 inch short link and a 15 inch long link.

TABLE 3

| | | SPRING TERMINATION |
|---|---|---|
| SLOT ANGLE | LIFTING ANGLE | POINT/PIVOT DISTANCE |
| 75°-150° | 50°-115° | 0.7″-2.8″ |

The parameters provided may be applied to various embodiments of the elevating lifting chairs and lifting mechanism. The parameters are dependent on one another. For example, the length of the lifting arms of the parallelograms will require different degrees of rotation to achieve the desired forces and extent of iso-elasticity. In general, particular combinations of slot angle, lifting angle, spring termination point to main pivot length, parallelogram short link length and parallelogram long link length will achieve the desired lifting force and iso-elasticity profile.

The concept of ‘iso-elasticity’ as relates to lifting means is explained by Garrett W. Brown's various patents, including, U.S. Pat. Nos. 8,066,251; 5,360,196; 7,618,016; 5,435,515; Re. 32,213; 6,030,130; 4,394,075; and 4,208,028 (the iso-elasticity explanations contained therein are incorporated herein by reference).

In an illustrative embodiment of the lifting mechanism the aspect-ratio of the lifting parallelogram sides is relatively low. Even when adjusted for maximum lifting power, an outsized amount of resilient force is exerted against a relatively short ‘lever arm’ (which may be an extension contiguous with or fixedly attached to a parallelogram linkages or side). In an illustrative embodiment the aspect ratio is 6:1, or approximately 6:1.

When adjusted for minimal lifting force, for example by a pin and hole adjustment or a slot, along which a spring termination pivot can be adjusted, these lever arms are shorter still—reduced in length by as much as 80%, and yielding aspect ratios up to 24:1. An illustrative aspect ratio range is 6:1-24:1. The optimum aspect ratio may depend, for example, on the lifting power of the resilient member and the lever arm.

A minimal lift pin position affects the lifting angle vs the spring axis as the spring now powers against a short lever arm, pushing at an inefficient lifting angle to counter the deviation from iso-elasticity caused by lowering the aspect-ratio of the lifting triangle.

A method is disclosed for adjusting lifting mechanism 348 that includes the selection, in combination, of the aforementioned parameters, in order to produce appropriate lifting for a range of payloads throughout the entire parallelogram excursion.

Various embodiments of elevating walker chairs and lifting mechanisms have been described, each having a different combination of elements. The invention is not limited to the specific embodiments disclosed, and may include different combinations of the elements disclosed or omission of some elements and the equivalents of such structures.

While illustrative embodiments have been disclosed, additional advantages and modifications will occur to those skilled in the art. Therefore, the invention in its broader aspects is not limited to specific details shown and described herein. Modifications may be made without departing from the spirit and scope of the invention. Accordingly, it is intended that the invention not be limited to the specific illustrative embodiments, but be interpreted within the full spirit and scope of the appended claims and their equivalents.

Claimed is:

1. A convertible seat comprising:
a saddle section having a rear section and a narrower front section extending from the rear section;
a thigh section connected to the saddle section by a hinge and foldable toward the rear saddle section;
the thigh section hinge having an axle disposed therethrough;
a seat deployment mechanism configured to transform the seat between a folded saddle configuration and an unfolded seat configuration; and
the saddle section configured to be elevated and lowered by a lifting mechanism;
wherein the seat deployment mechanism is configured to be activated by action of the lifting mechanism to elevate and lower the saddle causing the saddle and thigh section to automatically transform between the folded saddle configuration and the unfolded seat configuration, respectively.

2. The convertible seat of claim 1 wherein the thigh section, thigh section hinge and axle comprise:
a right thigh section connected to the saddle section by a right hinge and foldable toward the rear saddle section;
a left thigh section connected to the saddle section by a left hinge; and
the left hinge and right hinge having an axle disposed therethrough.

3. The convertible seat of claim 1 wherein the seat deployment mechanism comprises:
a cam affixed to the axle;
an elongated flexible component having a first end and a second end;
the flexible component first end configured to be connected to a lifting mechanism; and
the flexible component second end connected to the cam;
whereby rotation of the cam about the axle generated by the lifting mechanism raises the convertible seat and transforms the convertible seat into a saddle.

4. The convertible seat of claim 1 further comprising one or more seat deployment springs attached at one end to one or more bell crank(s) and attached at an opposite end to a spring axle, thereby biasing the thigh section(s) to a folded or unfolded position.

5. The convertible seat of claim 1 wherein in the unfolded configuration the right thigh section, left thigh section and saddle section together form a sitting surface.

6. An elevating walker chair comprising:
a seat according to claim 1;
a frame having a plurality of wheels attached thereto; and
the lifting mechanism attached to the frame.

7. The elevating walker chair of claim 6 wherein the lifting mechanism comprises:
a parallelogram structure:
a lifting spring, the force of which counters an occupant's weight;
a wiper arm attached to the parallelogram structure; and
wherein the first end of the flexible component is attached to the wiper arm.

8. The elevating walker chair of claim 7 wherein the lifting spring is configured to counterbalance the user's weight, thereby reducing the force required for the occupant to transition from a seated position to a raised saddle position.

9. The elevating walker chair of claim 6 wherein the seat deployment mechanism further comprises one or more seat deployment springs attached at one end to one or more bell crank(s) and attached at an opposite end to a spring axle thereby biasing the right thigh section and the left thigh section to a folded or unfolded position.

10. The elevating walker chair of claim 6 wherein in the unfolded configuration the thigh section and saddle section together form a sitting surface.

11. A method of rehabilitation comprising:
providing an elevating walker chair according to claim 6;
implementing mobility exercises using the elevating walker chair.
